(19) United States
(12) Patent Application Publication
(10) Pub. No.: US 2026/0258703 A1
(43) Pub. Date: Sep. 3, 2026

(54) AUTOMATICALLY RETRACTABLE MARINE LADDER

(71) Applicant: Trevor Wendell Fregeau, Chicago, IL (US)

(72) Inventor: Trevor Wendell Fregeau, Chicago, IL (US)

(21) Appl. No.: 19/302,976

(22) Filed: Aug. 18, 2025

Related U.S. Application Data
(63) Continuation-in-part of application No. 17/740,120, filed on May 9, 2022.

(51) Int. Cl. E06C 9/08; B63B 27/14; E04H 4/14

(52) U.S. Cl. CPC E06C 9/08; B63B 27/146; E04H 4/144

(57) ABSTRACT

An automatically retractable marine ladder, and a method of using the ladder. The ladder rotates between a horizontal/resting position, and an angular/in-use position, under at least in part the influence of a force-generating element, such as a pneumatic cylinder, motor, cantilever weight, spring, etc.

### PRIORITY CLAIM

This application is a continuation-in-part and claims priority to U.S. Ser. No. 17/740,120, filed May 9, 2022.

### BACKGROUND OF THE INVENTION

The present invention generally relates to marine ladders and, more specifically, to retractable marine ladders capable of connection to virtually any apparatus, such as a dock, boat, platform, raft, pool, etc.

Many recreational bodies of water, such as the Chain-o-Lakes in the United States, prohibit and fine submerged stationary ladders. While there are ladders on the market that can be removed or flipped up out of the water, they have various disadvantages, such as: difficulty to access or mount; visually obnoxious; heavy and/or difficult to move between in-use and stowed positions; taking up precious dock space; riddled with operational safety concerns; and having the capability of being accidentally left in the water. Inadvertently not removing the ladder from the water can lead to fines and weather damage, as well as foreign elements such as algae, seaweed, zebra mussels, barnacles, etc., accumulating on the ladder. Existing ladders also suffer from the infirmity of not being attachable to a range of apparatus, including docks, platforms, boats, rafts, pools, etc. Additionally, 90-degree ladders are impossible for many users to use.

Accordingly, there is a need for an automatically retractable marine ladder capable of attachment to a variety of apparatus and in a variety of different environments. There is also a need to provide such a ladder which allows accessibility to users of all ages, shapes and sizes to interact with the water.

### SUMMARY OF THE INVENTION

The objects mentioned above, as well as other objects, are solved by the present invention, which overcomes disadvantages of prior marine ladders, while providing new advantages not previously associated with them. This summary is provided to introduce a selection of concepts in a simplified form that are further described below in the Detailed Description, so that the claimed invention may be better understood. However, this summary is not intended to limit the scope of the claimed subject matter.

The automatically retractable ladder of the present invention is capable of attachment to a variety of apparatus, use in a variety of different environments, and is accessible to a wide range of users in all shapes and sizes.

In a preferred embodiment of the present invention, an automatically retractable marine ladder is provided, which includes a ladder having upper base and lower distal ends; a pair of opposing siderails; and a plurality of treads attached to the opposing siderails; a support tube pivotably attached to at least one of the siderails, the support tube includes a force generating element and is located closer to the base end than to the distal end, and the support tube being rigidly attached to a rigid frame leg or a fixed element, such as a dock or boat, located in or adjacent to a body of water. The ladder is generally horizontally positioned when not in use, and is movable to a predetermined angular position when the force generating element (e.g., cantilever, spring, motor, etc.) and/or body weight is exerted on one or more of the siderails or one of the treads located distal of the support tube, thereby enabling ladder users to exit the dock or boat and enter the water. Following a user's exit from the ladder, the ladder automatically rotates from the predetermined angular position to the generally horizontal position under influence of the force generating element. Preferably, the support tube may be quickly decoupled from the fixed element (such as in a few minutes or less), thereby freeing the marine ladder from the fixed element so that it may be removed and repaired, or quickly coupled to an alternative fixed element, for example.

The force generating element may include various items such as: a cantilever weight attached to the ladder and located at or adjacent the upper, base end of the ladder; a spring providing a rotational force applied to the support tube; a motor applying a rotational force to the support tube; an electric or other motor exerting a rotational force on the ladder; or a combination of a cantilever weight located at or adjacent the base end of the ladder, and an element (such as a spring or motor) applying an additional rotational force to the support tube.

The fixed element may include one or more of the following: a standing sectional dock; a standing wheel-in dock; a floating dock; a swim raft; a mobile swim loading platform; a breakwall; a bulkhead; a boat; an above-ground pool; or an in-ground pool.

The ladder siderails may be attached or integrally formed with a ladder handrail, such as a generally U-shaped handrail, which may generally extend around the ladder. A transfer bar extending from a frame leg may be designed to be easily graspable, and positionable adjacent the top of the ladder, to facilitate the user's entry to and exit from the ladder.

The predetermined angle of the ladder may be any desired angle, such as about 60° relative to ground. Preferably, rotational movement of the ladder occurs in a smooth, controlled fashion; one preferred example of a rate of rotational movement which is safe is when the ladder is returning to its resting position at about one foot/second. A dampener associated with the support tube may be used to smooth ladder movement as the ladder comes to a rest.

The support tube may be pivotably attached to the ladder using at least one hinge mechanism, which may include a stop pin rigidly attached to a siderail that works in conjunction with the hinge mechanism to fix ladder movement to the predetermined angular position during ladder use. An axis pin may also be used to allow the hinge plate and the entire ladder to rotate relative to the fixed element; the axis pin may have a first end rigidly attached to the hinge mechanism, and a second end free to rotate relative to a siderail.

In an alternative embodiment, the support tube may include may include various elements which enable the ladder to pivot relative to the fixed frame legs. In a particularly preferred embodiment, a pivot cylinder may be rigidly attached to a side of the ladder, and provide support for the rotary point of the ladder. A pivot inside ring, slidable over the pivot cylinder, may act as a cylindrical spacer to create a low-friction fitting to allow the ladder to more easily rotate about the pivot cylinder. A pivot outside ring may be rigidly connected to the opposing frame legs, to hold the pivot points together and protect them from impact. The pivot cylinder and the pivot outside ring may rotate around each other, with the aid of the pivot inside ring as acting as a low-friction spacer. A pivot gasket may facilitate this rotation against the main ladder by reducing friction there. A passageway within the pivot cylinder allows placement of a fastener such as a bolt for attachment to the ladder legs, allowing a quick decoupling of the pivot cylinder from the fixed frame legs, allowing the ladder to be easily removed, and repaired or attached to a different fixed element.

In an alternative embodiment, an automatically retractable marine ladder is provided, having: upper base and lower distal ends; a pair of opposing siderails; a plurality of treads attached to the opposing siderails; a support tube pivotably attached to at least one of the siderails, the support tube being located closer to the base end than to the distal end, and the support tube being rigidly attached to a frame leg or other fixed element located in or adjacent to a body of water; and a force generating element associated with the support tube and positioned adjacent the base end of the ladder. The ladder is generally horizontally positioned when not in use, and is movable to a predetermined angular position when force or body weight is exerted on one or more of the siderails or one of the treads located distal of the support tube, thereby enabling a ladder user to exit the ladder into the water. Following exit of the user from the ladder, the ladder automatically rotates from the predetermined angular position to the generally horizontal position at least in part under influence of the force generating element.

Preferably, the ladder treads are curved, and shaped to hug the contours of a human foot as the ladder rotates. In one preferred embodiment, at least the top tread has first and second substantially planar sections separate by a curved section, such that the first substantially planar section presents a substantially flat contact surface to a user foot when the ladder is in the generally horizontal position, and the second substantially planar section presents a substantially flat contact surface to a user foot when the ladder is in the predetermined angular position. Preferably, to minimize sharp angles which might cause pain to the user's feet, the two substantially planar sections, if connected by straight lines, would form an obtuse angle.

In yet another embodiment of the invention, a method is provided for using an automatically retractable marine ladder having upper base and lower distal ends, a pair of opposing siderails, a cantilever weight positioned at or adjacent the base end of the ladder, a plurality of treads each connecting the opposing siderails, and a support tube pivotably attached to at least one of the siderails, wherein the support tube is rigidly attached to a fixed element located in or adjacent to a body of water, and the ladder is generally horizontally positioned when not in use, comprising the steps of: (a) a user mounting the ladder from the fixed element and exerting force or body weight at a point above the support tube and on one or more of the siderails or one or more of the treads, thereby causing the ladder to move to a predetermined angular position; (b) the user using the ladder to climb down the ladder and then exit the ladder into the body of water; (c) the ladder automatically retracting to the generally horizontal position at least in part under influence of the cantilever weight; (d) when the user wishes to re-mount the ladder, the user exerting force or body weight at a point below the support tube and on one or more of the siderails or one or more of the treads, thereby causing the ladder to move to the predetermined angular position, enabling the user to climb the ladder and then exit the ladder to the fixed element; and (e) the ladder once again automatically retracting to the generally horizontal position at least in part under influence of the cantilever weight.

Preferably, the support tube can be quickly decoupled from the fixed element (such as in a few minutes or less), thereby freeing the marine ladder from the fixed element, and then quickly coupled to an alternative fixed element.

### DEFINITION OF CLAIM TERMS

The terms used in the claims of the patent are intended to have their broadest meaning consistent with the requirements of law. Where alternative meanings are possible, the broadest meaning is intended. All words used in the claims are intended to be used in the normal, customary usage of grammar and the English language.

“Planar” as used in the claims (with reference to the top ladder step) means substantially flat, and not perfectly flat (i.e., flat enough to provide a user foot with comfort when a planar portion is supporting the foot).

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a front and side perspective view of one preferring embodiment of a marine ladder of the present invention, pivotably attached to a standing dock, and located in a resting/horizontal position;

FIG. 1A is a front and side perspective view of the marine ladder shown in FIG. 1, in an unattached and in-use position;

FIGS. 2-4 are top plan, bottom elevation and top elevation views, respectively, of the ladder shown in FIG. 1;

FIG. 5-7 are right-side elevation, bottom plan and left-side elevation views, respectively, of the ladder shown in FIG. 1;

FIG. 8 is a front and side perspective view of the ladder shown in FIG. 1, pivoted to an in-use position, and attached to a standing dock;

FIG. 8a is a view of FIG. 8 in a resting position, and FIGS. 8b-8c are partial, enlarged perspective view showing the left foot/heel applying pressure to engage use of the ladder (8b) and showing the ladder in its in-use position as a user transfers to or from ladder to dock (8c);

FIG. 9 is a partial, enlarged side and front perspective view, with the left hinge plate removed, of a middle portion of the marine ladder of FIG. 1, showing the hinge with the ladder in the generally horizontal (retracted and resting) position;

FIG. 10 is a partial, enlarged side and front perspective view, with the left hinge plate removed, of a top portion of the ladder shown in FIG. 9, when the ladder has been moved to the in-use position;

FIG. 11 is an enlarged front and side perspective view of the assembled hinge bracket;

FIG. 12 is a view similar to FIG. 11 but showing a disassembled, parts view of the hinge bracket;

FIGS. 13-14 are exploded rear/side and front/side perspective views of the hinge bracket assembly shown in FIG. 11;

FIGS. 15-16 are interior and exterior side/front perspective views, respectively, of the hinge plate shown in FIG. 11;

FIGS. 17-19 are assembled rear/side, assembled front/side, and disassembled perspective views, respectively, of an exemplary mounting bracket assembly for use with a standing dock;

FIG. 20 is an exploded front/side perspective view of an exemplary hinge end plate and mounting bracket for a standing dock leg;

FIG. 21 is an exploded front/side perspective view of an exemplary mounting bracket for connection with a standing dock;

FIG. 22 is an exploded front/side perspective view of an exemplary hinge and mounting bracket for connection to a standing dock on one end, and to the hinge bracket assembly connecting to the marine ladder of the present invention, on the other end;

FIGS. 23-24 are exploded, side perspective views of the exemplary hinge plate of the present invention, with the exterior side of the hinge plate removed, showing the position of the stop pin when the ladder is in resting/horizontal (FIG. 23) and in-use (FIG. 24) positions;

FIG. 25 is a side/front perspective view of siderail sub-structure 12a, with multiple apertures 12b for receiving fasteners (not shown);

FIG. 26 is a partial, exploded side/front perspective view of the rear of the siderail sub-structure of FIG. 25;

FIG. 27 is an exploded, front/side perspective view of an exemplary, modular ladder arm;

FIG. 28 is an exploded, partial rear/side perspective view of a portion of an exemplary right ladder arm;

FIGS. 29-30 are exploded perspective views of the right-side and left-side, respectively, exemplary ladder siderails of the ladder of the present invention, showing ladder tread mounting blocks;

FIG. 31 is a partial exploded perspective bottom view of exemplary siderails and treads;

FIG. 32 is a partial exploded perspective top view of exemplary siderails and treads;

FIGS. 33-34 are exploded bottom and top perspective views, respectively, of exemplary ladder treads;

FIG. 35 is an exploded top/side perspective view of exemplary ladder treads;

FIG. 36 is a rear/side perspective view of the U-shaped handle components;

FIGS. 37-38 are partial, exploded top and bottom views of the removable weight section;

FIG. 39 is a partial, exploded rear/side perspective view of an interior view of the exemplary ladder;

FIG. 40 is a partial, exploded rear/side perspective view of an interior view of the exemplary siderail including sub-structure;

FIGS. 41-42 are X-ray views of the hinge plate when the ladder in in horizontal/resting and in-use positions, respectively;

FIGS. 43-44 are interior and X-ray partial perspective views, respectively, of siderail components;

FIG. 45 is an X-ray view of the assembled, U-shaped handle and removable weight;

FIG. 46 is a front/side perspective view of the ladder with treads removed, revealing the tread mounting blocks;

FIG. 47 is a partial, exploded rear perspective view of the ladder shown with treads removed, and FIG. 48 is the same view of the ladder shown with treads;

FIG. 49 is a view similar to FIG. 47 showing the treads attached to mounting blocks using set screws;

FIG. 50 is a view similar to FIG. 47 showing the treads with plastic covers outfitted with anti-slip texture;

FIGS. 51-54 are perspective views of connections for the ladder of the present invention attached to a towable loading platform 200 having a mounting bracket 210;

FIGS. 55-58 are perspective views of connections for the ladder of the present invention attached to a floating dock 220 having a mounting bracket 221;

FIGS. 59-62 are perspective views of connections for the ladder of the present invention attached to a different floating dock 222 having a mounting bracket 223;

FIGS. 63-66 are perspective views of connections for the ladder of the present invention attached to a standing dock system 224 having a mounting bracket 225;

FIGS. 67-70 are perspective views of connections for the ladder of the present invention attached to a bulkhead/breakwall 226 having a mounting bracket 227;

FIGS. 71A-D, 72A-D, 73A-D and 74 are perspective views of connections for the ladder of the present invention attached to a floating dock 228 having a mounting bracket 228a equipped with a wedge hinge 229 mountable on the extended square tubing of the invention, eliminating the need for the bottom and axial/fulcrum assembly;

FIG. 73E is a perspective view of the ladder of the present invention attached to a floating dock 228;

FIGS. 75A-D are perspective views of connections for the ladder of the present invention attached to a standing dock system 230 with mounting brackets 231;

FIGS. 76A-H are perspective views of connections for the ladder of the present invention attached to another floating dock system 232 having a mounting bracket 232a equipped with a wedge bracket 233;

FIGS. 77A-H and 78A-F are perspective views of a torsion rod suspension with a hinge bracket, to cause ladder rotation;

FIG. 79A-E is a perspective view of a hydraulic and elastic system in conjunction with a wedge hinge bracket for causing ladder rotation;

FIG. 80A-F is a perspective view of an exposed spring system in conjunction with a wedge hinge bracket for causing ladder rotation;

FIG. 81A-H is a perspective view of an internal strap spring system used in conjunction with a wedge hinge bracket for causing ladder rotation;

FIGS. 82A-C, 83A-B, 84A-B and 85 are perspective views of a spring steel and limiting material system for causing ladder rotation;

FIG. 86 is a left-side perspective view of another embodiment of the retractable marine ladder of the present invention, shown in the retracted, horizontal position;

FIG. 86A is a view similar to FIG. 86 in which a user has stepped onto the ladder, causing the ladder to rotate clockwise to a predetermined angular position;

FIG. 87 is a front perspective view of the marine ladder shown in FIG. 86, also showing the frame which can be attached to a fixed element such as a dock or boat, and which can be anchored into the ground below the water;

FIG. 88 is a top view of the marine ladder shown in FIG. 86;

FIG. 89 is a planar perspective view of a portion of a cross-sectioned portion of right-side guide rail 107;

FIG. 90 is a planar perspective view of elements related to the ladder's ability to pivot/rotate relative to a fixed element such as a dock or boat (pivot outside ring 113 is removed);

FIG. 90A is a view similar to FIG. 90, including pivot outside ring 113;

FIG. 91 is a right-side, partial perspective view showing an upper portion 124 of right-side leg 130b;

FIG. 92 is a rear and side partial perspective view showing the pneumatic cylinder mounted to a strut on a cross-brace between the frame legs, for causing the ladder to rotate;

FIG. 93 is a planar perspective view of a suitable pneumatic cylinder for use in rotating the ladder;

FIG. 94 is a left-side perspective view of the retractable marine ladder shown in FIG. 86;

FIGS. 95-96 are top/side and front perspective views, respectively, of the top dock bracket;

FIGS. 97-98 are side and top/front perspective views, respectively, of the top step shown in FIG. 87;

FIGS. 99-100 are side and top/front perspective views, respectively, of one of the lower steps shown in FIG. 87;

FIGS. 101-102 are front and top/front perspective views, respectively, of the underwater base;

FIG. 103 is an enlarged front perspective view of the rotation bumper also shown in FIG. 87;

FIG. 104 is an enlarged side perspective view of the rotation bumper gusset also shown in FIGS. 87 and 92;

FIG. 105 is a top and side enlarged partial perspective view of the middle pivot cylinder which provides support for the rotary point of the ladder;

FIG. 106 is a top and side partial perspective view of an upper portion of the ladder in the angled position;

FIG. 107 is a view similar to FIG. 106 with a user's feet positioned on the upper planar portion of the first (top) step;

FIG. 108 is a top and side partial perspective view of an upper portion of the ladder in the generally horizontal position, with a user's feet positioned on the lower planar portion of the first (top) step;

FIG. 109 is an enlarged top and side partial perspective view of a left-side of the ladder and the readily removeable connection between a ladder leg and the dock;

FIG. 110 is a side perspective view of FIG. 109;

FIG. 111 is a top and side perspective view of a preferred embodiment of the automatically retractable ladder of the present invention, shown in the angled position, with foam-covered steps; and

FIG. 112 is a partial side perspective view of the ladder in an angled condition.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

Referencing the drawings in general, placing one foot on the first tread lowers the long end of the ladder into the water, while raising the U-shaped hand rail to a comfortable height. Once the ladder has lowered to a predetermined angle, such as 60°, the user can then place both hands on the U-shaped hand rail, both feet on the treads, and proceed into the water. While the ladder can be designed to move to any angle during use, 60° from ground has been found particularly advantageous, as at this angle the treads are substantially level, facilitating use. After a user dismounts from the ladder, the ladder mechanics will start to retract the treads out of the water at a slow, safe speed. When users wish to use the ladder to exit the water, they simply reach up approximately a foot, pull the ladder down into the water, and begin to swim onto the ladder. As soon as the ladder rotates from its normal retracted, level position to its predetermined angle, the user can proceed up the ladder and exit the water. The ladder will then slowly return to its retracted, level position. The mechanics safely hold users at the predetermined angle for ease of use while walking out of the water instead of climbing.

Dynamic components were designed and tested to ensure there are no pinch-points for fingers or limbs. The ladder's self-leveling side-car design ensures it complies with water rules and regulations, frees up dock space, maximizes areas of installation, and keeps your ladder clean and free of debris, such as zebra mussels, barnacles, algae, seaweed, slime, et cetera. Ladder treads/rungs may also be added or removed as needed, such as for comfort or change of use.

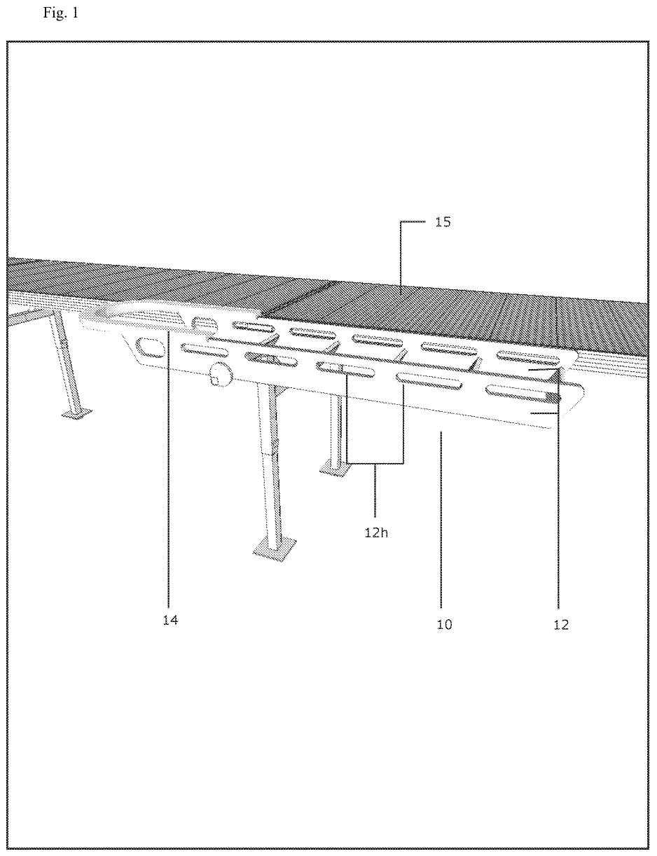

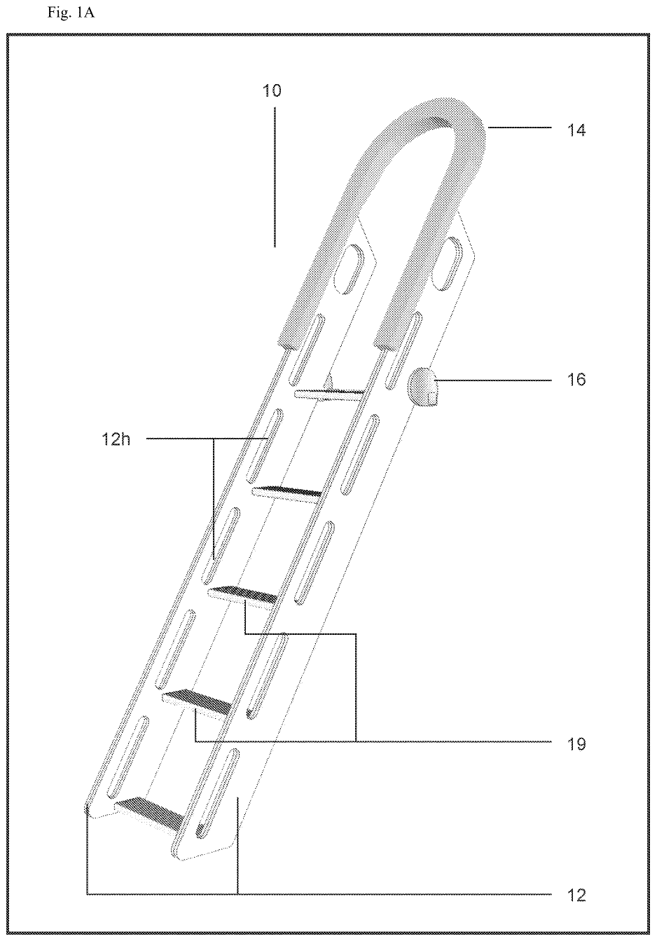

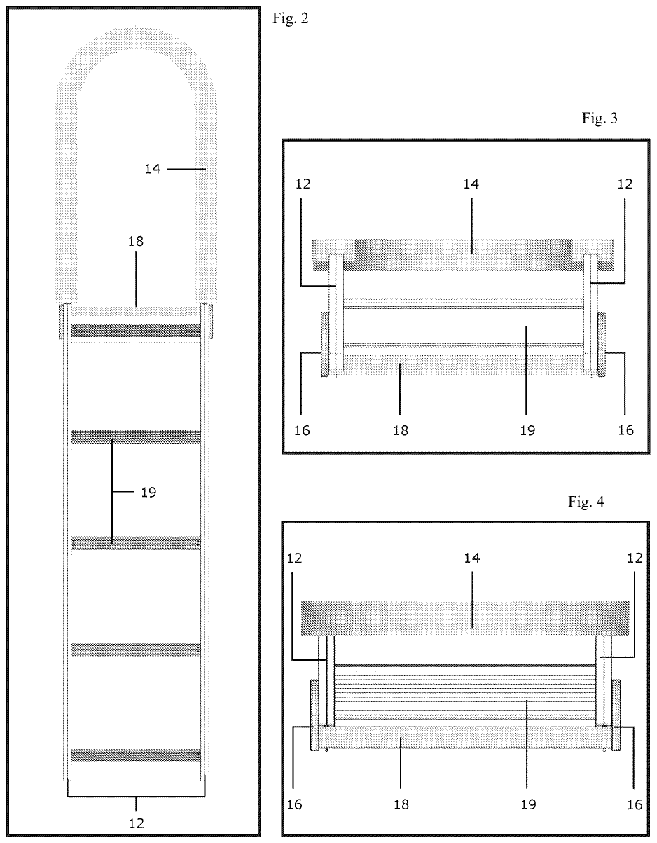

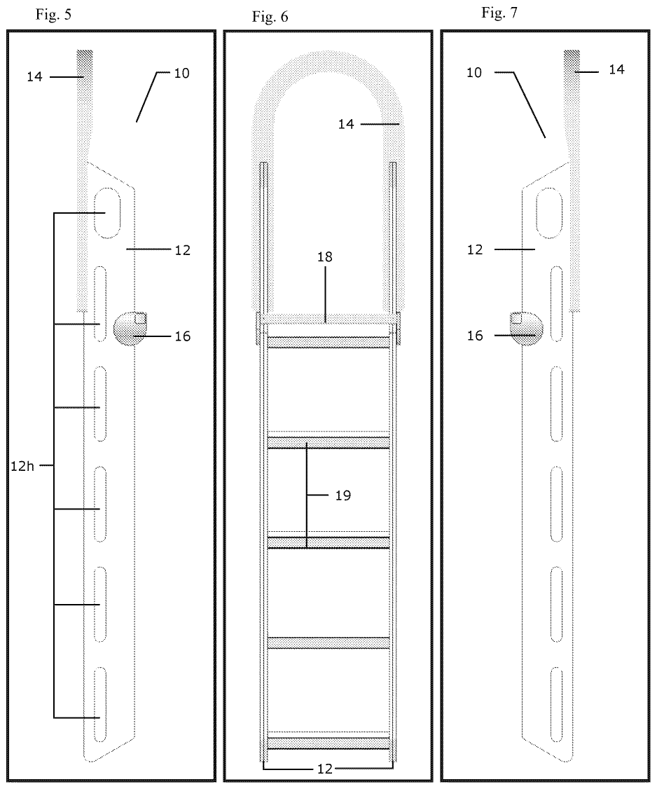

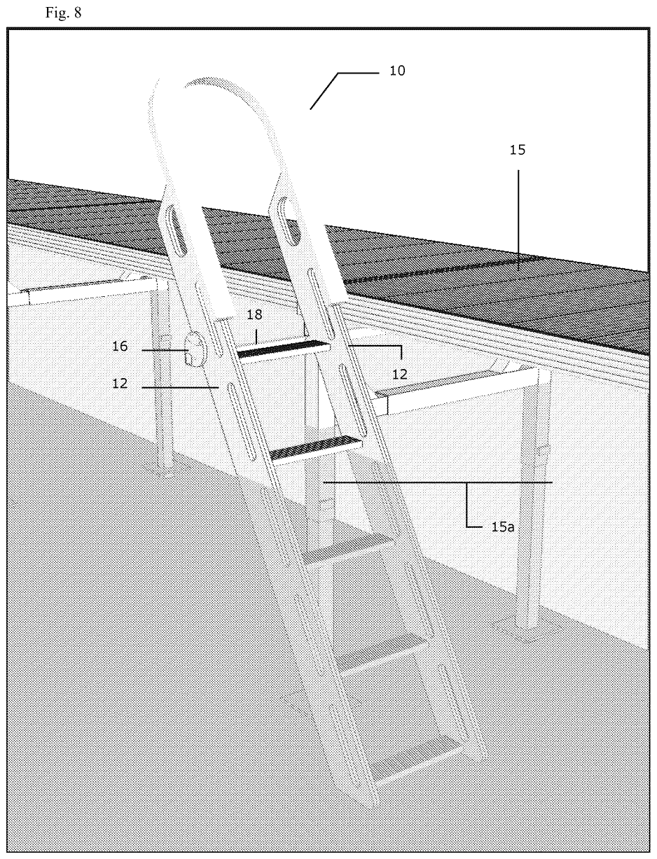

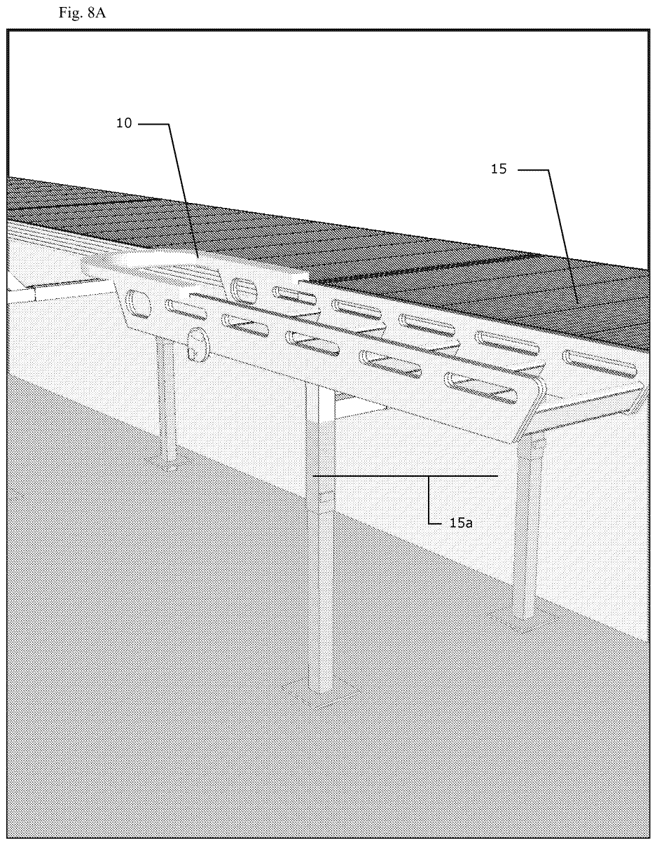

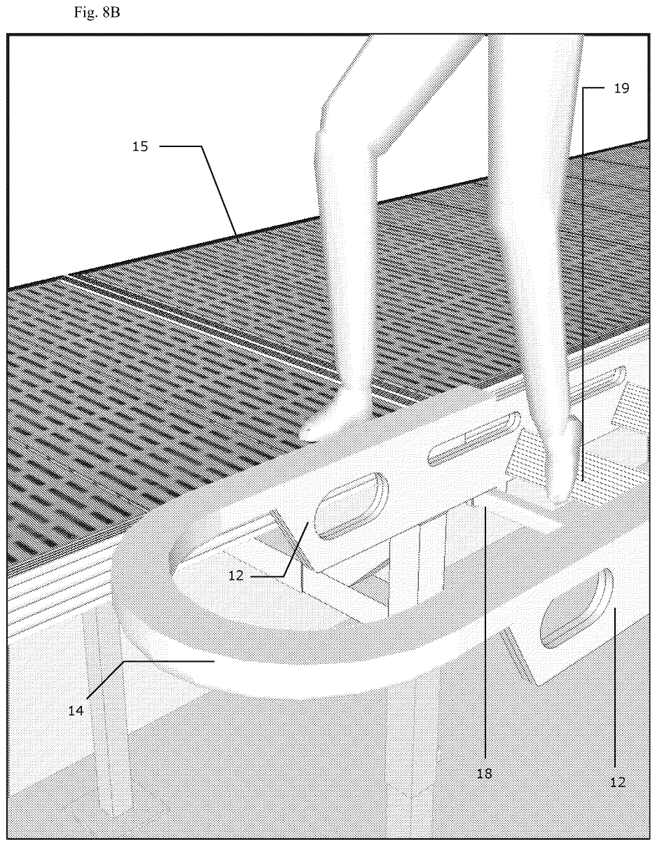

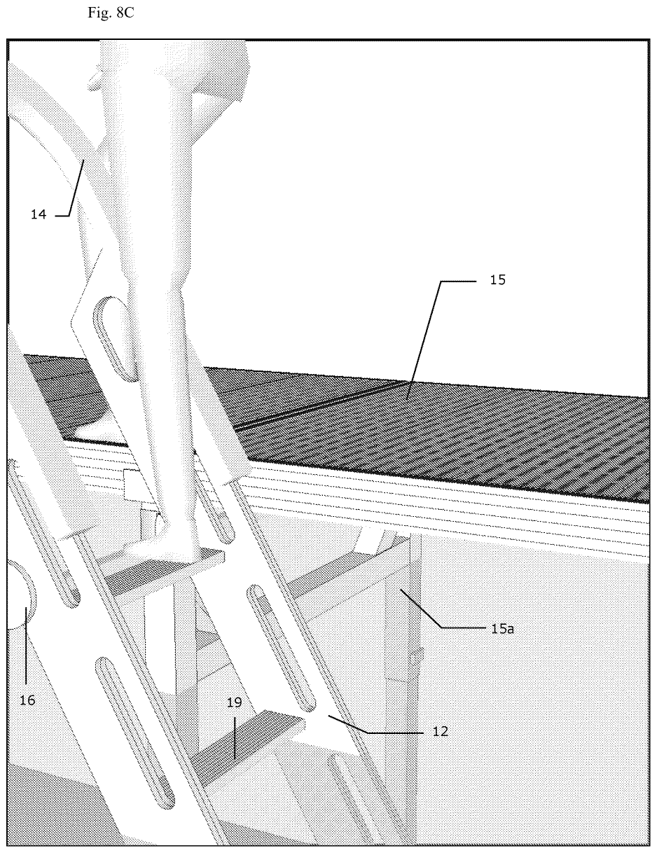

Referring now to FIGS. 1-14, marine ladder 10 of the present invention is self-retracting, and may be connected to a variety of fixed and non-fixed support objects, including docks 15 with dock legs 15a, piers, swimming pool sides, flotation devices, a tripod, boats, etc.

In one preferred embodiment, marine ladder 10 includes ladder siderails 12, which may be two unitary sides, or each side may consist of a plurality of pieces (which may be attached using fasteners attached by, e.g., wooden, plastic or metal strips, as further described below). Ladder siderails 12 may have graspable apertures 12h. Ladder treads 19 may connect opposing siderails 12. Handrail 14 may be attached to the top of the ladder siderails 12. Support arm 18 may be connected by struts, or using a unitary piece of metal tubing, as further described below.

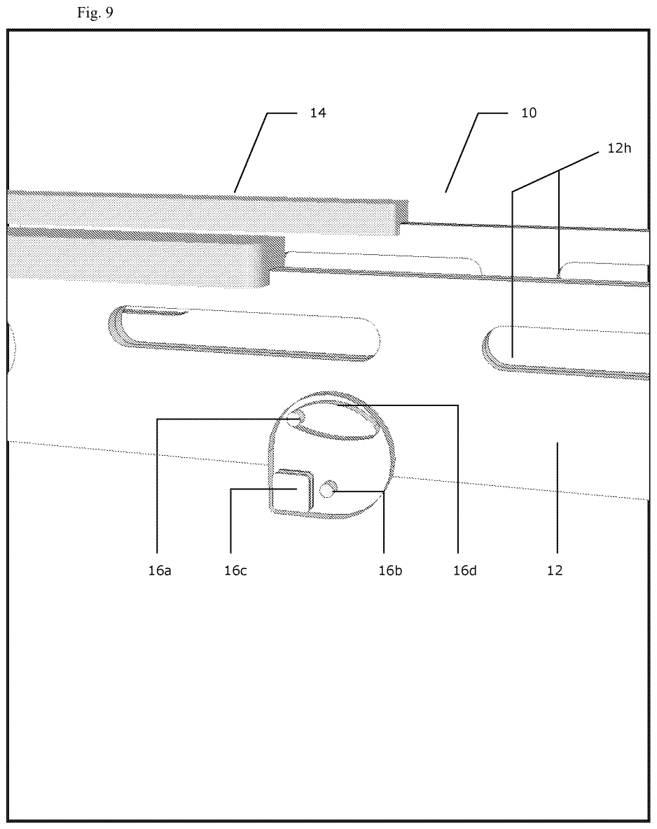

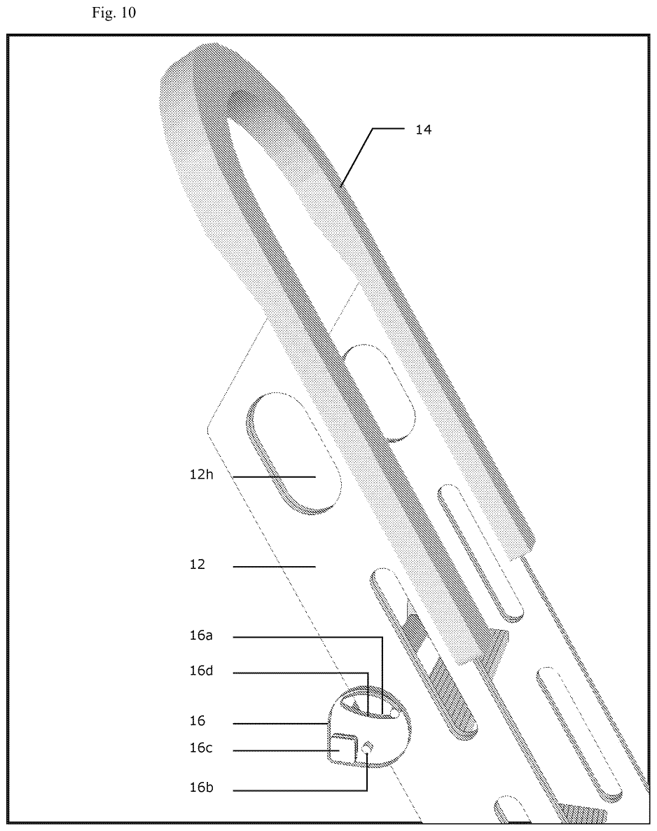

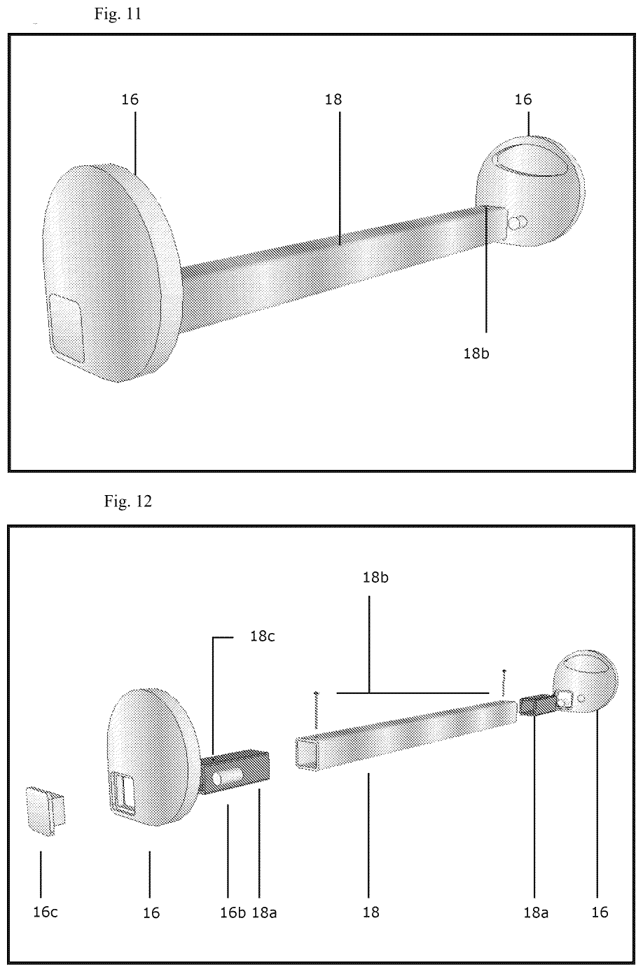

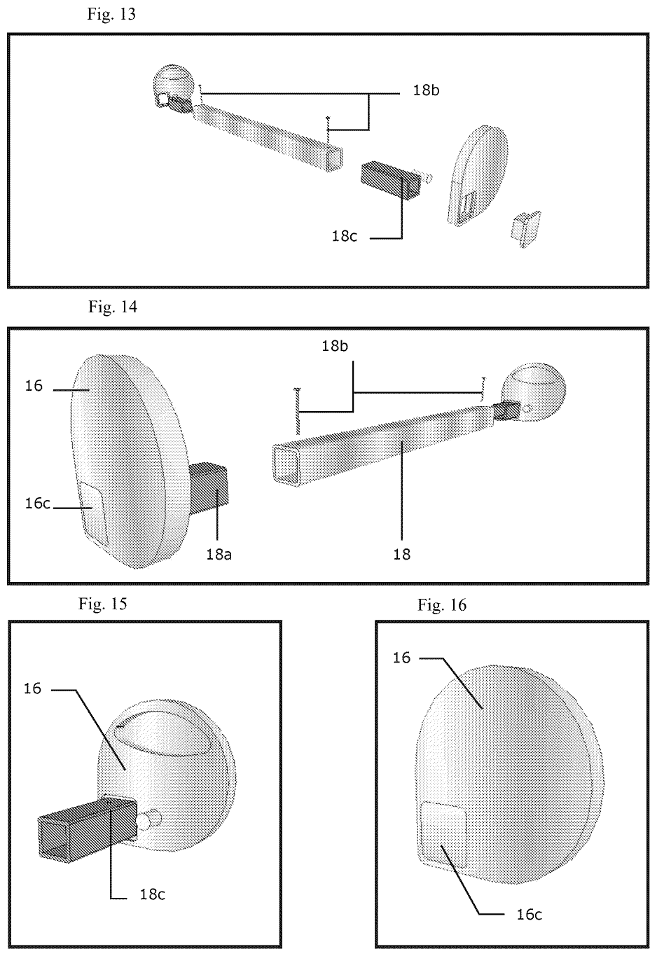

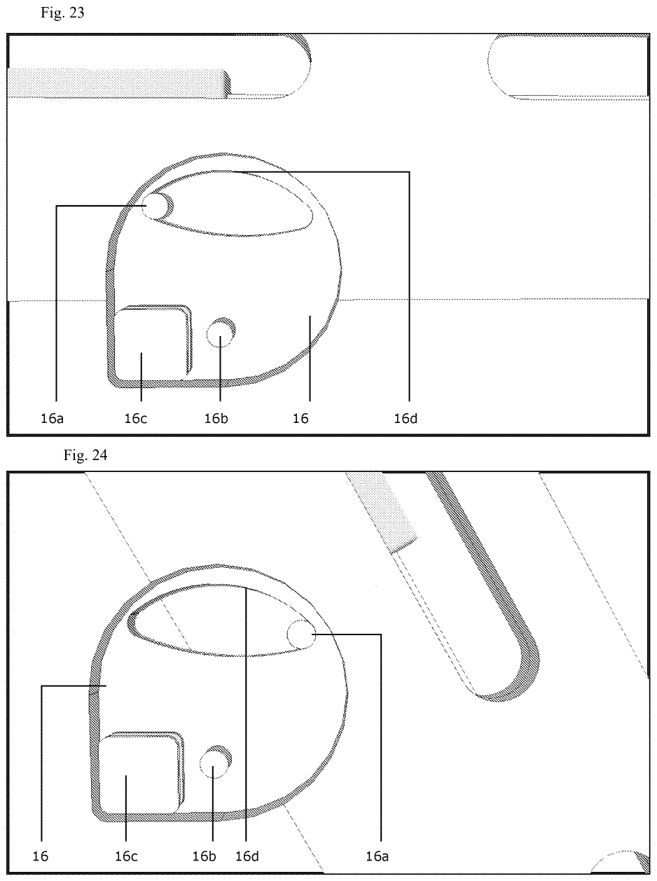

Referring to FIGS. 9 and 23, stop/limiting pin 16a is shown when the ladder is in the resting/retracted/horizontal position. Stop pin 16a may be welded to the (e.g., aluminum) subframe of the siderail. (Handheld laser welding may be a preferred way to provide weldments for the ladder, to provide fine and clean welds.) As also explained below, and shown in the drawings, in the preferred embodiment, when hinge plate 16 is attached to tube 18, a fixed end of the axis/fulcrum pin is rigidly attached to the hinge plate, while the free end of axis/fulcrum pin 16b is inserted into a nylon bushing 12f located on siderail substructure 12a (see FIG. 26), where pin 16b is free to rotate within this bushing relative to the siderail, allowing the hinge plate and the entire ladder to rotate relative to the dock. Referring to FIGS. 10 and 24, when the ladder is rotated into an in-use position by a user, hinge plate 16 can be configured, such as by the geometry of cutout 16d and the location of stop/limiting pin 16a relative to cutout 16d, such that stop/limiting pin 16a can be used to maintain the ladder in whatever angular position is desired. However, as shown in FIGS. 10 and 24, it has been found that a particularly preferred angular orientation for the ladder is 60° from ground as, at this position, the ladder treads are substantially parallel to ground, facilitating user travel along the ladder. The outer portions of pins 16a and 16b (i.e., the projecting portions on the outer surface of the side rail of the ladder) may be concealed for aesthetic and/or safety reasons by a plug to cover the opening on the side not being used to attach to the dock. Removal of this plug (see FIGS. 12-13) allows for the hinge assembly to be mounted for either a right-side or left-side attachment to a dock or other apparatus. The inner portions of the pins (on the inside surface of the side rail of the ladder) may be concealed within the ladder tread.

In a particularly preferred embodiment, each siderail 12 forms a single, unitary length, and there are no visible fasteners or cover plates, for enhanced aesthetics. Achieving this modular design is further described below.

Referring now to FIGS. 11-12, the ladder may be pivotably attached to an apparatus such as a dock, using a universal hinge mechanism, such as hinge bracket shown, which includes reversible (right/left mounted) hinge plates 16 connected by support arm 18. In the preferred embodiment, hinge plates 16 are made of milled aluminum, and are attached by telescoping aluminum tube 18 spanning the hinge plates. Aluminum sub-tubes 18a are connected at opposing ends of tube 18, such as by using retractable, quick-release axis/fulcrum set pin 16b, which may be concealed by cover plate 16c. Referring to FIG. 12-14, top pins 18b may also be used to secure tube 18 at its opposing ends to sub-tubes 18a. The hinge bracket assembly, including quick-release plug 16c, allows the ladder of the present invention to be easily disconnected from and reconnected to docks, boats, platforms, pools, etc., enabling the ladder to be easily utilized on other applications or for storage. Connection and disconnection are also facilitated by the lightweight nature of the ladder, whose aluminum and composite or plastic components enable a (e.g.) 5-tread, 8-foot-length ladder to only weigh about 40 pounds, for example.

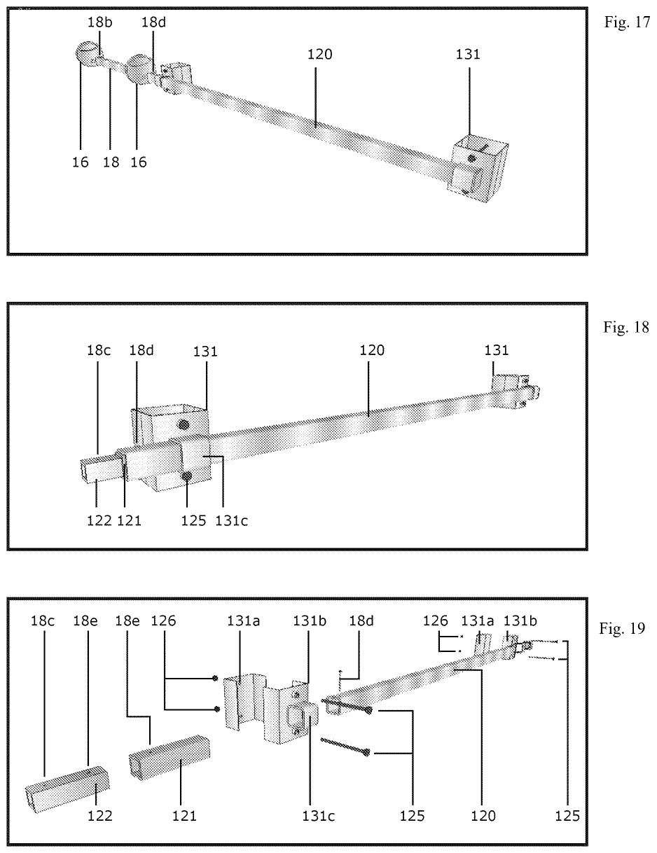

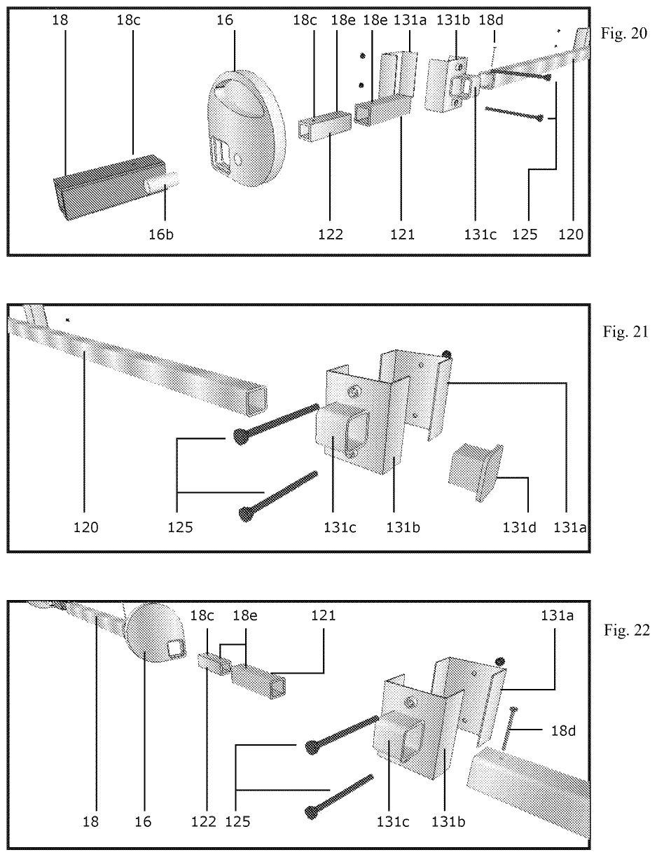

Referring now to FIGS. 17-22, an exemplary mounting bracket assembly for use with a standing dock is shown, including telescoping aluminum tubes 120, 121, 122 connecting hinge assemblies 131a, 131b to each other, using bracket 131c mounted on hinge 131b, fasteners 125 and nuts 126. Bracket assembly 16/18 may be connected to the end of the mounting bracket, as shown in FIG. 17 and discussed above.

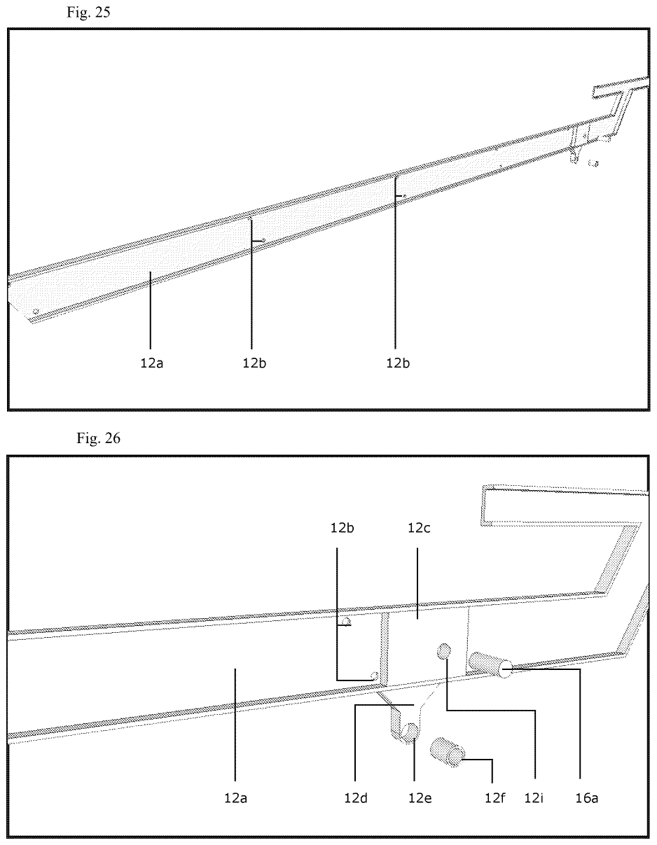

Referring now to FIGS. 25-26, an exemplary siderail sub-structure 12a is shown, with multiple apertures 12b (which may but need not be threaded, tap and die) for receiving threaded fasteners (not shown). Excess aluminum portion 12c is used to provide structural strength for stop pin 16a, and includes aperture 12i which receives stop pin 16a. Downward-projecting aluminum bracket 12d has an aperture 12e for receiving nylon bushing 12f. (Axis/fulcrum pin 16b, not shown, is inserted through nylon bushing 12f and aperture 12e.)

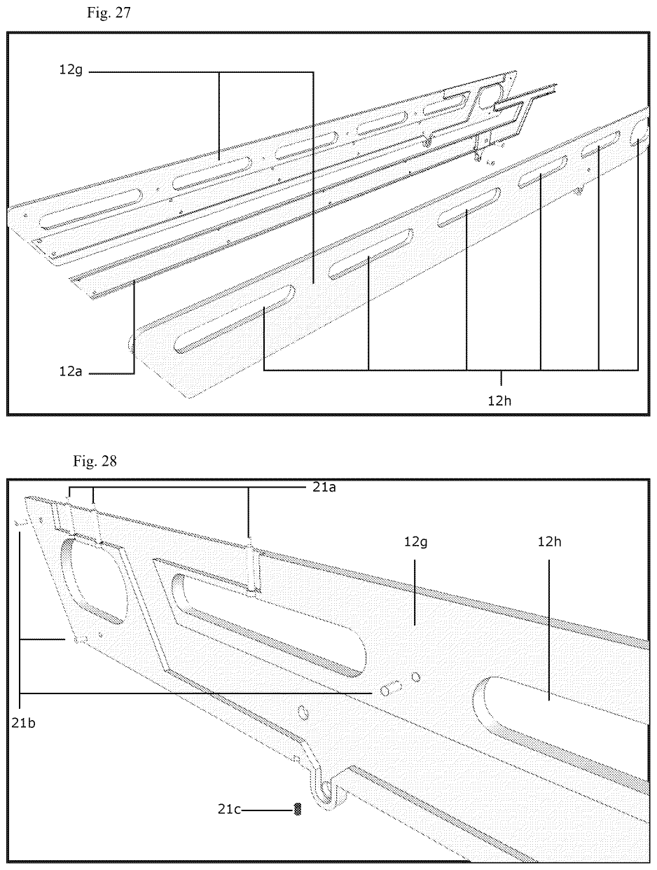

Referring now to FIGS. 27-28, modular ladder siderail 12 may be formed by surrounding and encasing middle rail sub-structure 12a, which may be made from aluminum, with sub-structures 12g, which may be made from (ABS) plastic or a composite material. Referring to FIG. 28, cap head screw 21a may be used on each siderail 12 to mount U-shaped handle 14 to each siderail 12. Alignment pins 21b may be used to secure (align for gluing) milled (e.g., ABS plastic) sheet sub-structure 12g to each other. Alignment dolls 21b may be used to line up the two milled siderail substructures 12g when welding the plastic together to encase aluminum sub-structure 12a. Rubber dampener 21c may be located to rest against support tube 18 as the ladder rotates, dampening the ladder movement as it is forced to rest.

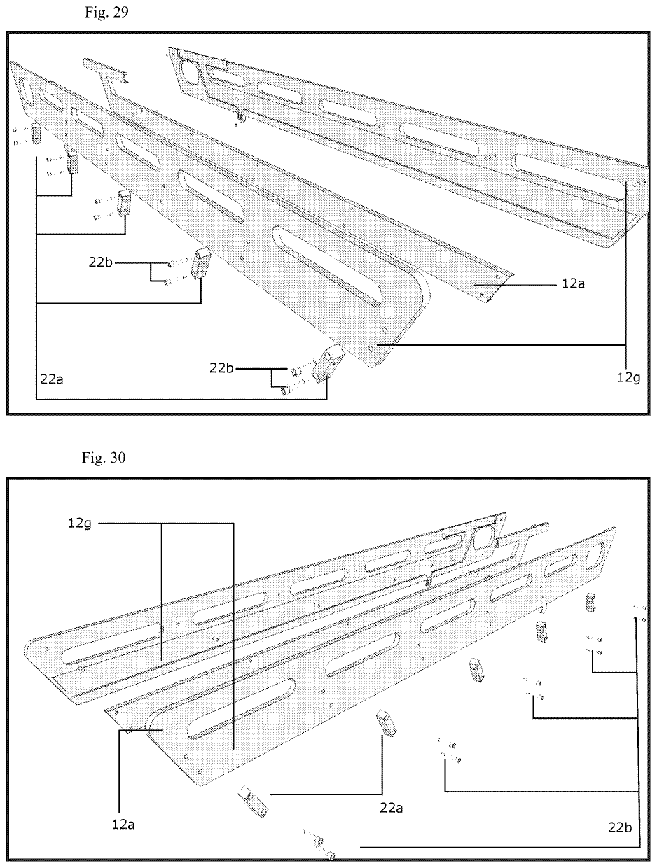

Referring to FIGS. 29-30, ladder tread mounting blocks 22a are shown, secured to the ladder siderails 12 by cap head screws 22b, which thread into apertures 12b (shown at FIGS. 25-26).

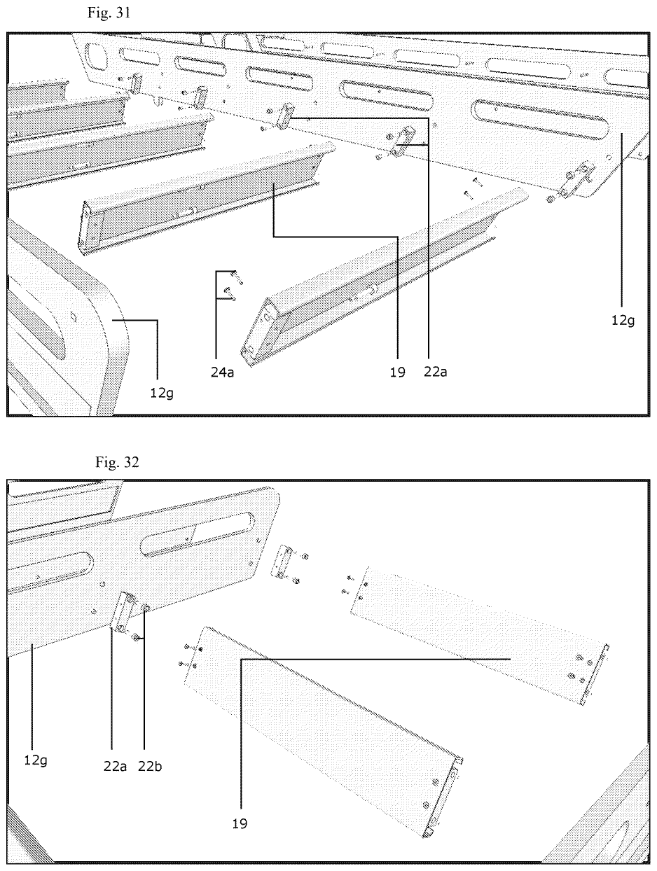

Referring to FIGS. 31-32, extruded aluminum treads 19 are attached to side mounting blocks 22a using set screws 24a. Extruded aluminum channels may be cut to length and drilled to provide a ladder tread with sufficient strength.

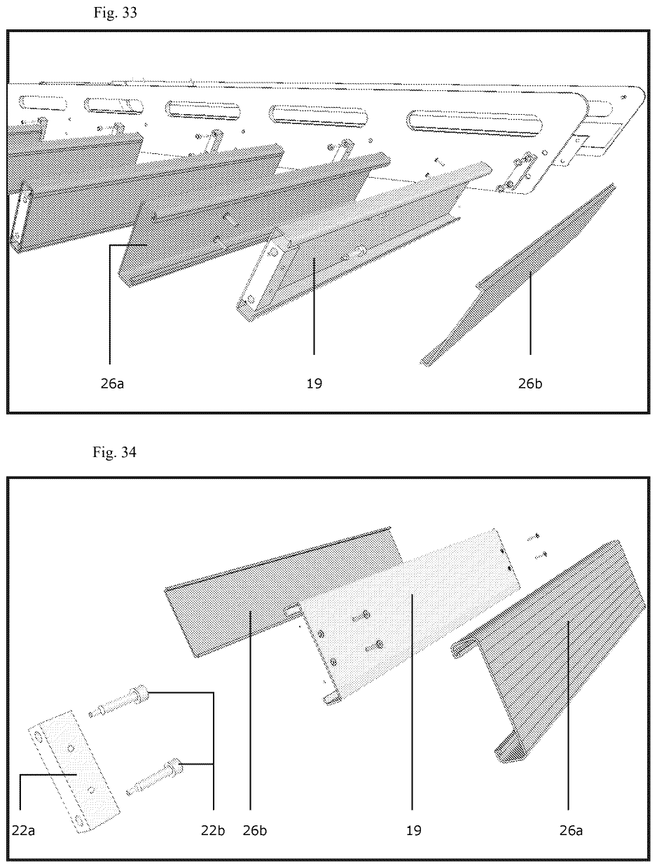

Referring now to FIGS. 33-34, extruded plastic 26a may be used to cover the top and sides of the extruded aluminum treads, while extruded plastic 26b may be used to cover the bottom of the aluminum treads.

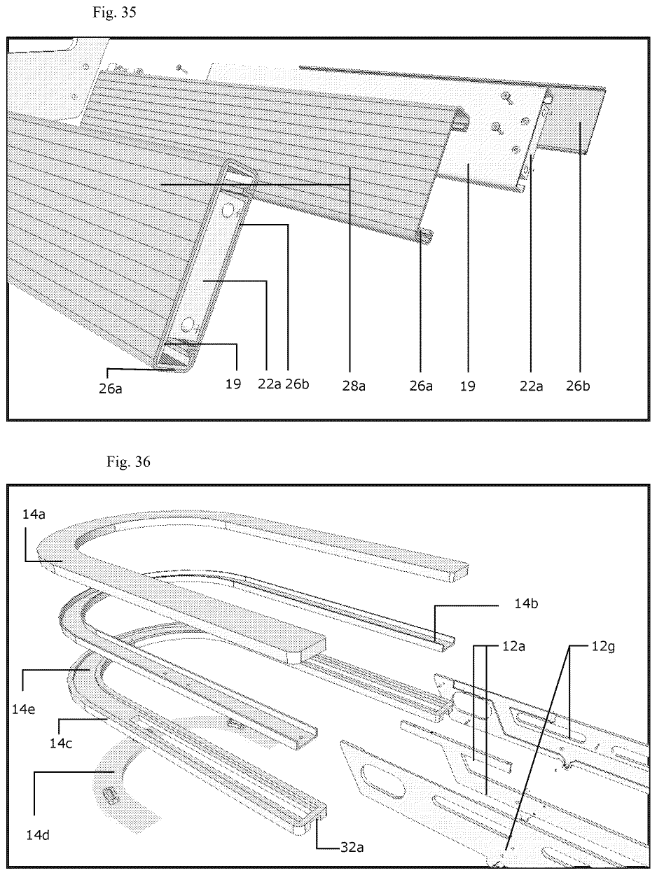

Referring to FIG. 35, anti-slip texture 28a is shown as added to top and bottom tread covers 26a, 26b, respectively.

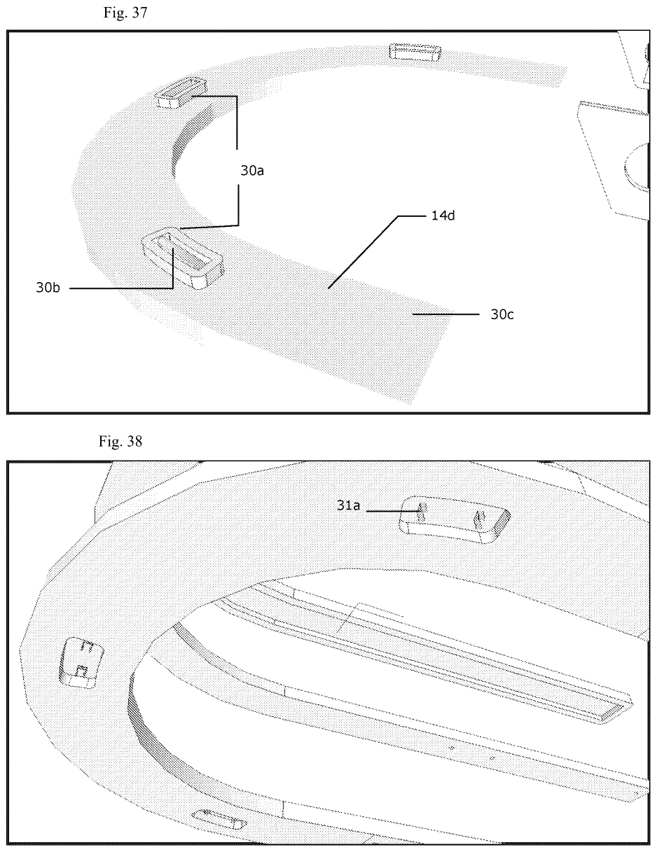

Referring to FIGS. 36-38, components for U-shaped handle 14 are shown. Thus, top plastic sub-structure 14a and bottom plastic sub-structure 14c encase aluminum sub-structure 14b. Removable weight section 14d may be used as a counterweight, to ensure that the ladder automatically rotates back to the horizontal/resting position after a user has left it. Fasteners (not shown may be used to attached assembled U-shaped handle 14 to opposing siderails 12. Referring to FIGS. 37-38, alignment tabs 30a on weight section 14d carry aluminum bars 30b which clip/latch into spring clips 31a located within recessed pockets on the bottom of substructure 14c, to attach weight section 14d to the U-shaped tube 14 (see FIGS. 37-38). Referring to FIG. 36, the lower surface of the ends of siderails 12 insert within channels 32a (FIGS. 36, 39-40) on substructure 14c (channel 14e is the recession for aluminum substructure 14b). Pockets 32a are pockets on the ends of substructure 14c for accommodating the lower front ends of sidearms 12.

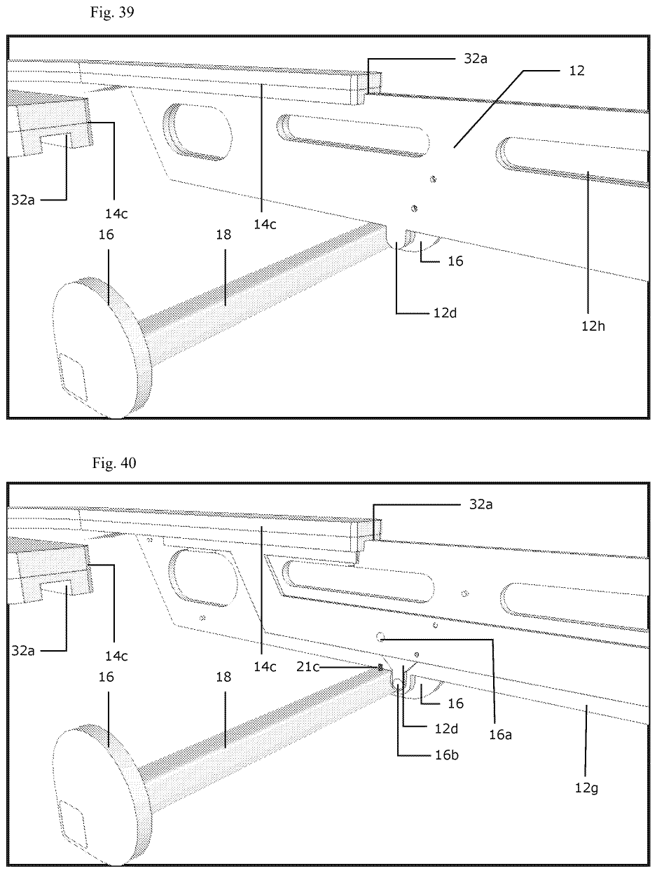

Referring now to FIGS. 39-40, the (e.g., plastic) bottom 14c of U-shaped bar 14 includes a recessed pocket 32a, for accommodating the upper surface of siderail 12 (fasteners or glue, not shown, may be used to attach the U-shaped bar to the siderail). Referring to FIG. 40, it can be seen that projecting portion 12d of the siderail sub-structure provides the structural housing for axis pin 16b. Also, rubber dampener 21c cushions the ladder as it comes to a stop stopped when moving from the in-use to horizontal position, or vice-versa.

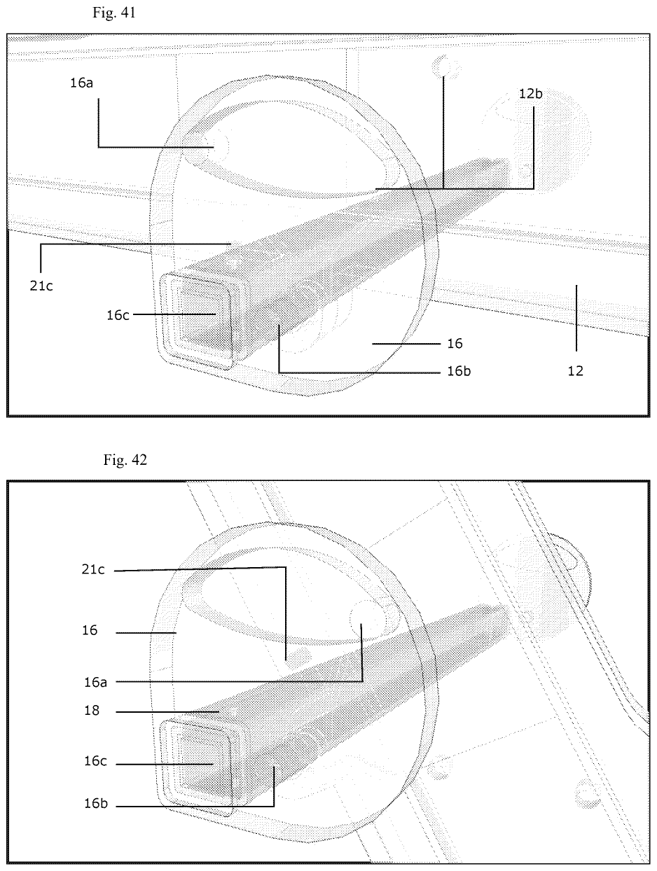

Referring to FIGS. 41-42, siderail sub-structure apertures 12b received threaded inserts (not shown) to attachment to tread mounting blocks 22a. Rubber dampener 21c rests against aluminum hinge spanning tube 18. The location of stop and axis/fulcrum pins 16a, 16b, respectively, allows for all tread mechanics to be identical, i.e., reducing the necessary size of the side plates, and increasing the distance between fulcrum pin 16a and the end of the first or top ladder tread 19, thereby increasing ease of use when boarding the ladder from the dock.

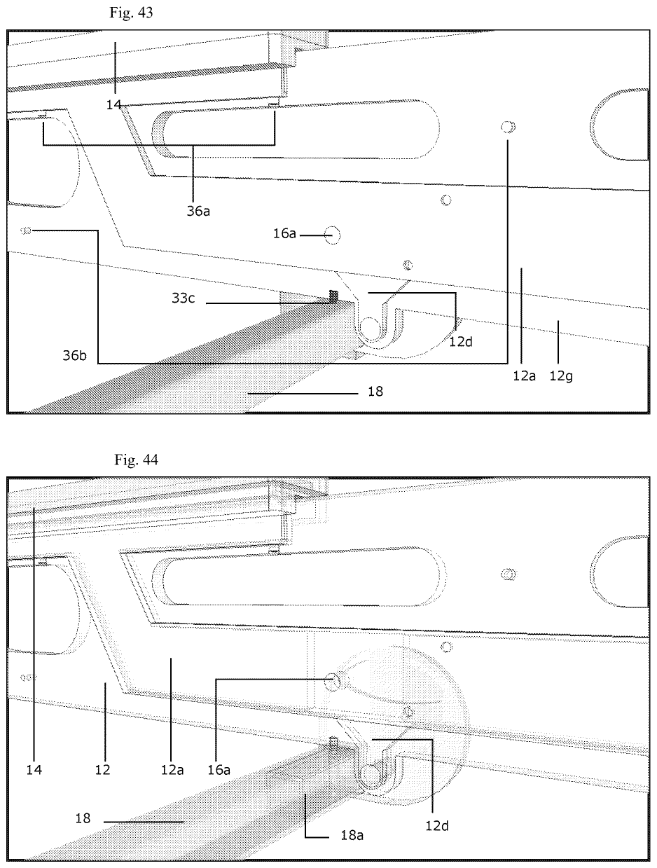

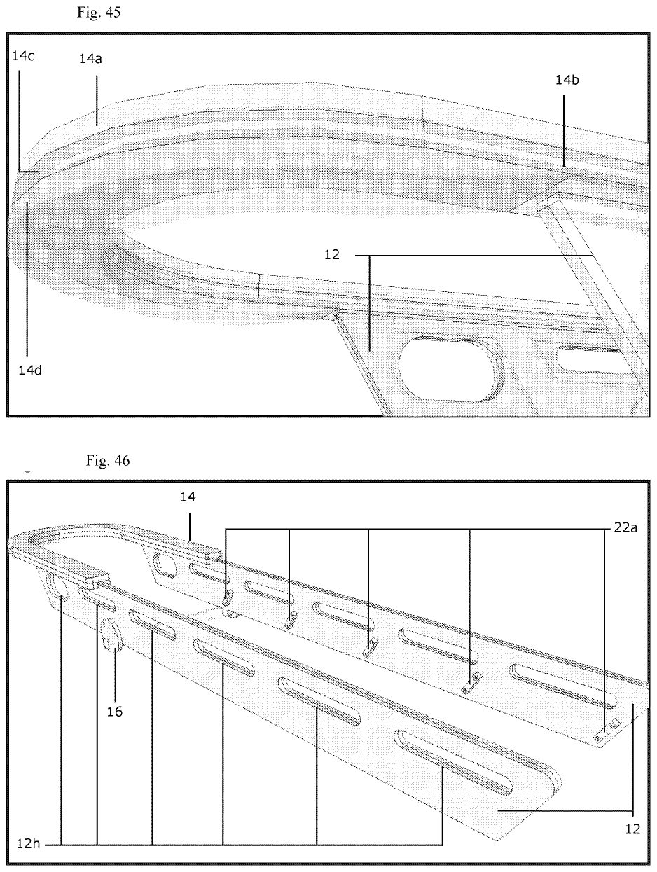

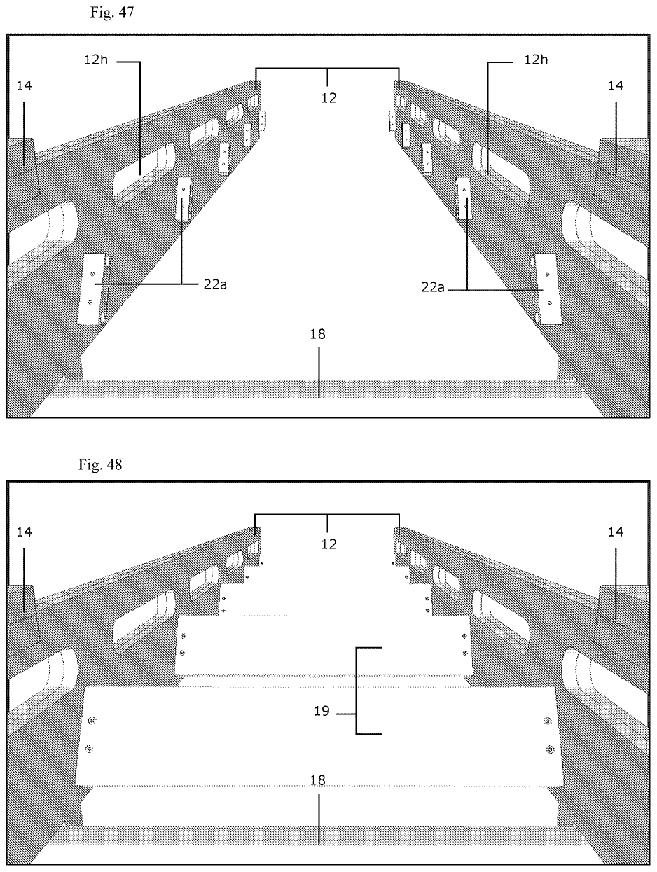

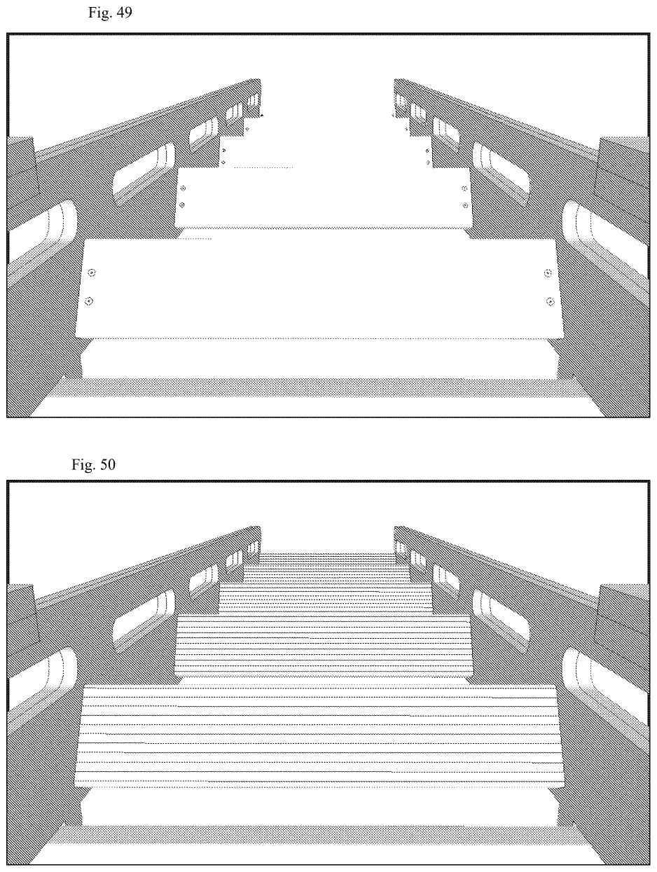

Referring to FIGS. 43-44, cap screw 36a is recessed into the (e.g., aluminum) siderail substructure 12a, connecting the siderail with the U-shaped bar. Alignment pins 36b on (e.g., plastic or composite) siderail 12 are also shown.

Still referring to FIGS. 1-44, an explanation of using the ladder is now provided. A user approaching the ladder from a platform can simply place her/his foot on the first tread and press down with the heel of the foot, for example. Because the fulcrum and the pressure point from the heel are relatively close together, the ladder will lower in a slow and controlled fashion, with the counterweight of the weighted section 14d aiding in this movement, while rubber dampener 21c ensures that as the ladder moves to a stopped position, whether in the in-use or horizontal position, the stop will be relatively smooth and controlled, not jerky. Once the ladder hits the water and the U-shaped handle comes up to meet the user's hands, the surface tension of the water further help to control the lowering of the ladder as the user's full body weight is transferred to the ladder during the ladder's descent, until the stop pin and hinged side plates interact to fix the ladder in its in-use (preferably 60°from ground) position.

In one preferred embodiment, the marine ladder takes about 5-7 seconds to right itself after use, and the bottom end of the ladder travels approximately 4.5-feet during this travel, so its angular speed is roughly about 1 foot/second, which provides a safe, slow and controlled rate of speed for ladder movement.

When the ladder is in its in-use position, at 60° from ground, the ladder is generally at eye height for a person of average height. If a swimmer already in the water wishes to climb the ladder in order to exit the water, the following procedure is used. The ladder will be in its horizontal/resting position. The user pulls down on the ladder while starting to climb on the ladder, causing the ladder to rotate to its in-use position. The user climbs the ladder. As the user steps off the ladder onto a dock, for example, the surface tension of the water and the calibrated counterweight work together to bring the ladder back to its horizontal resting place in a safe and controlled manner.

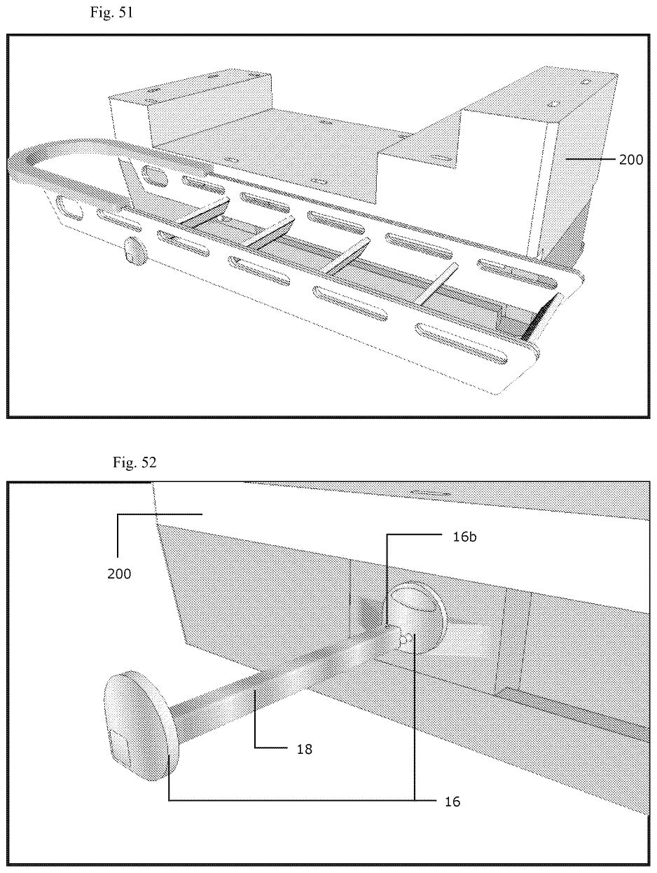

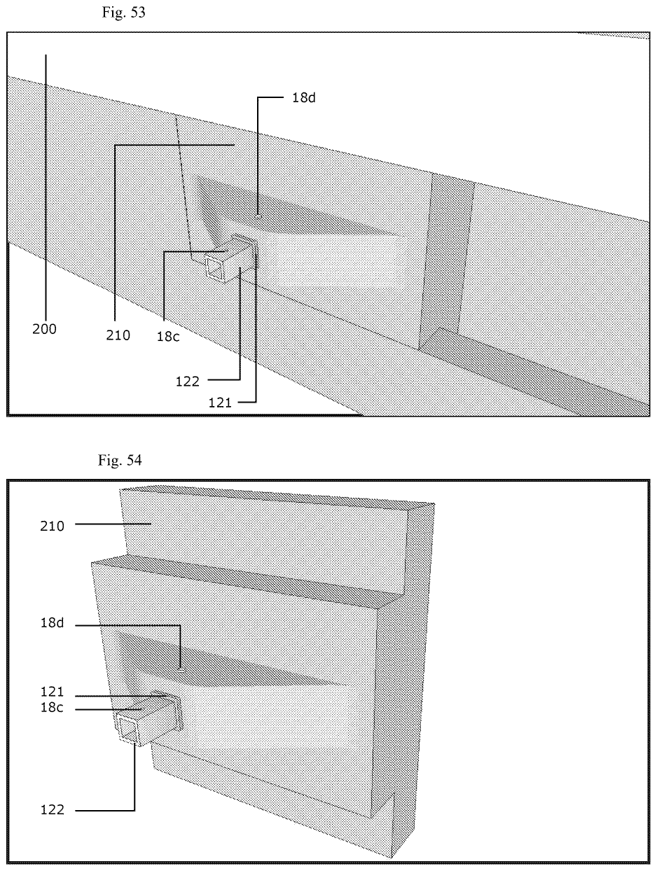

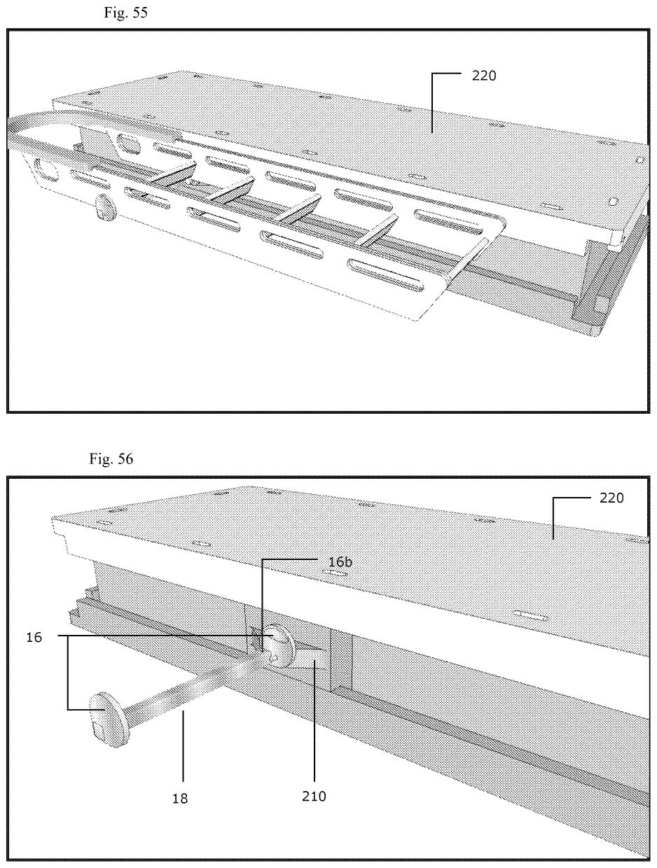

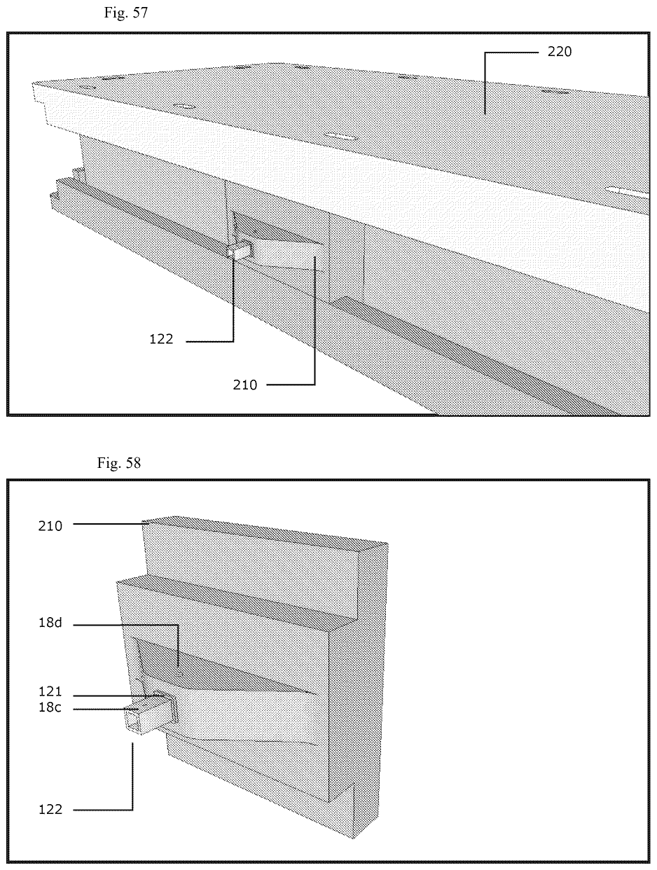

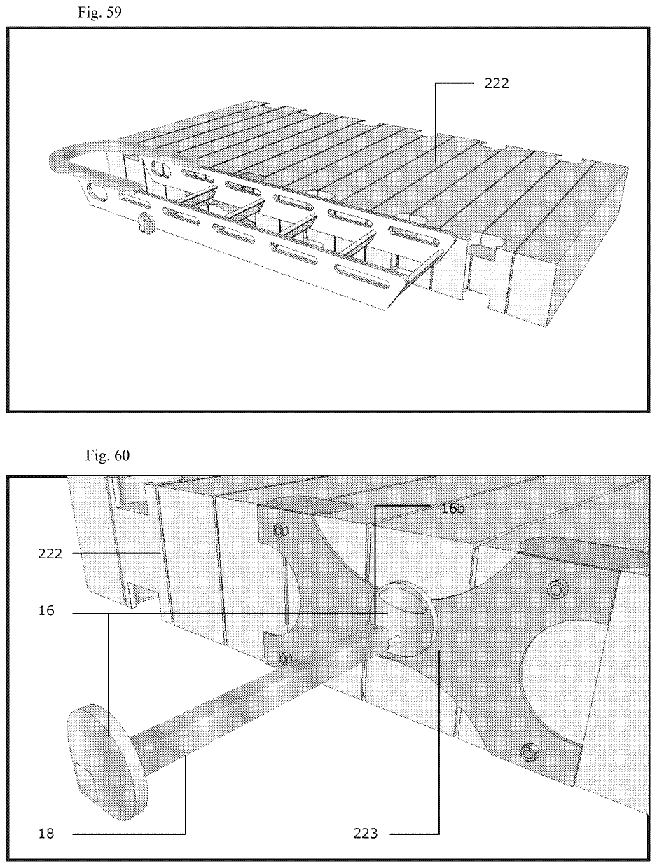

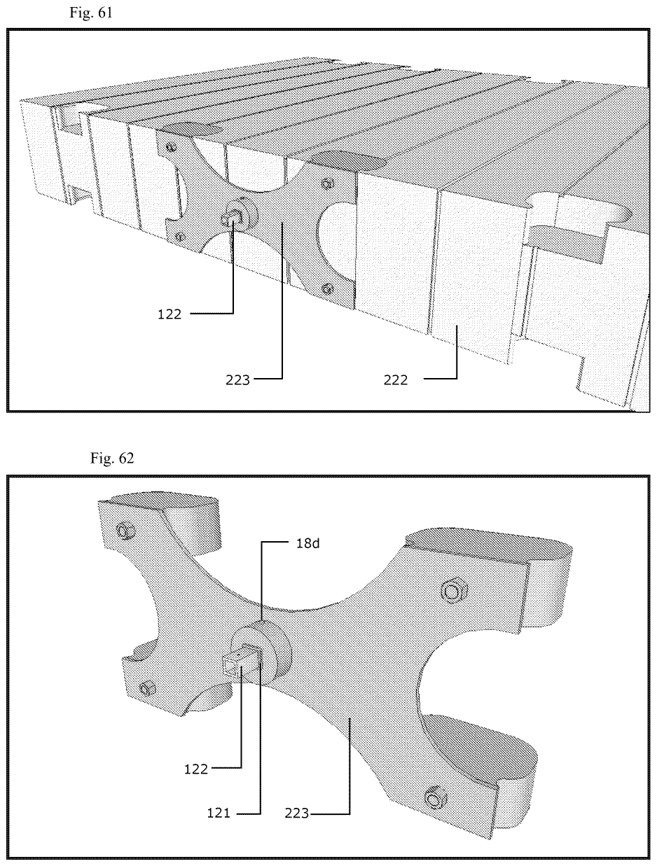

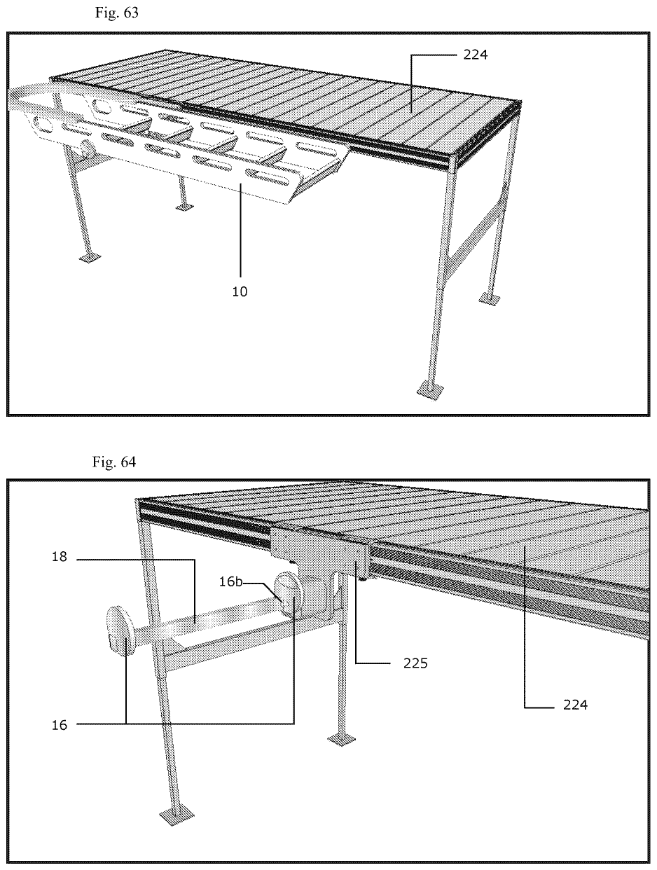

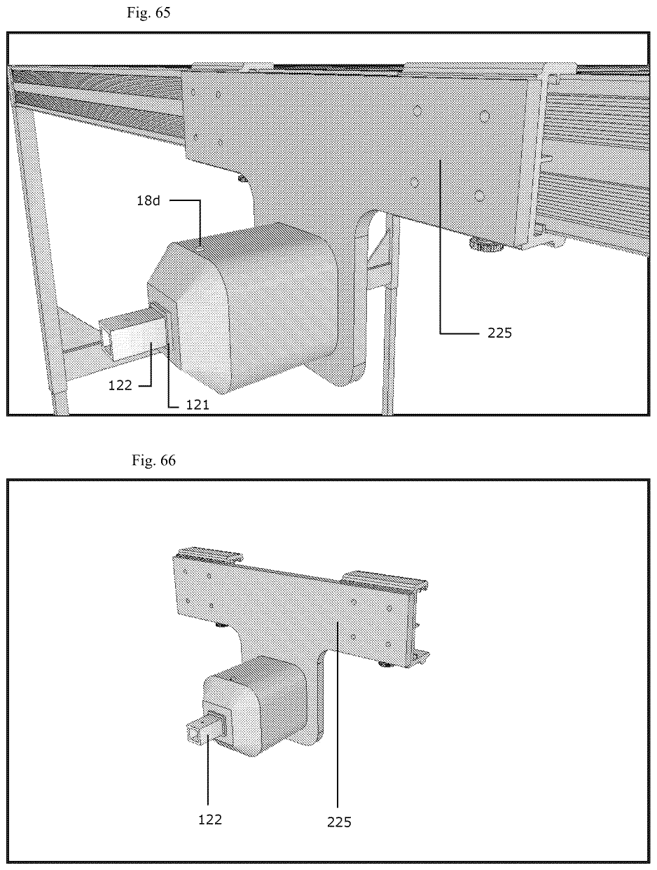

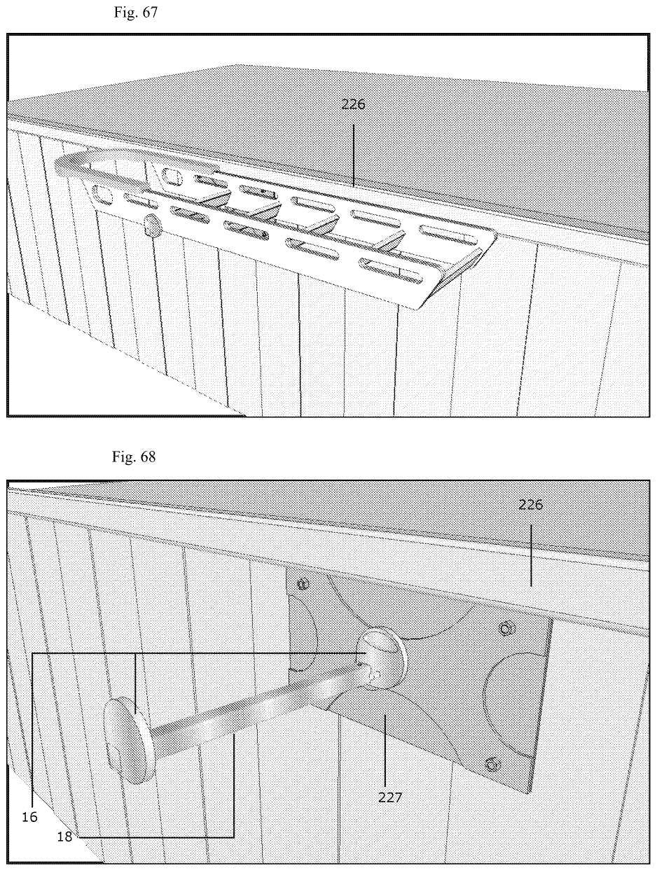

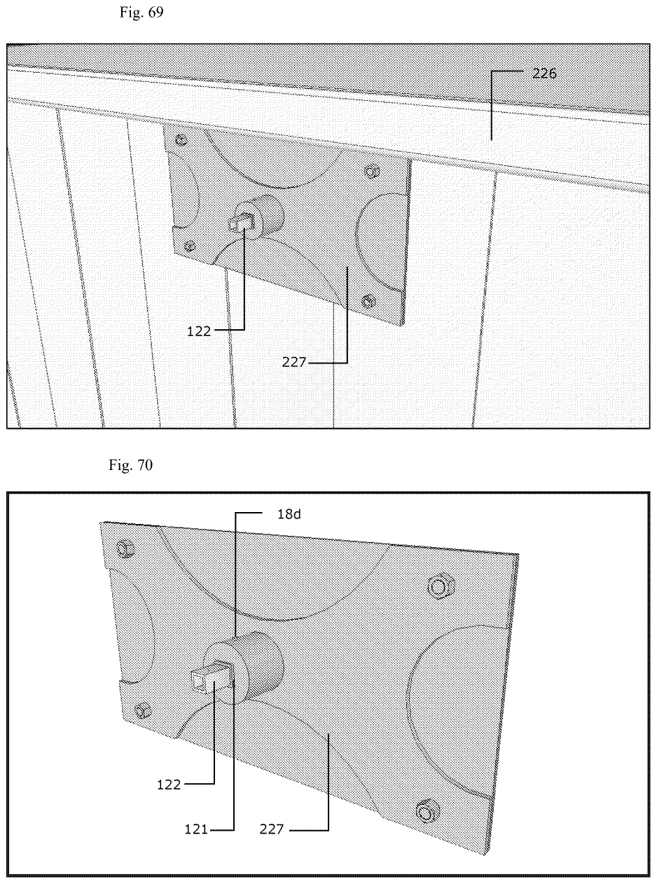

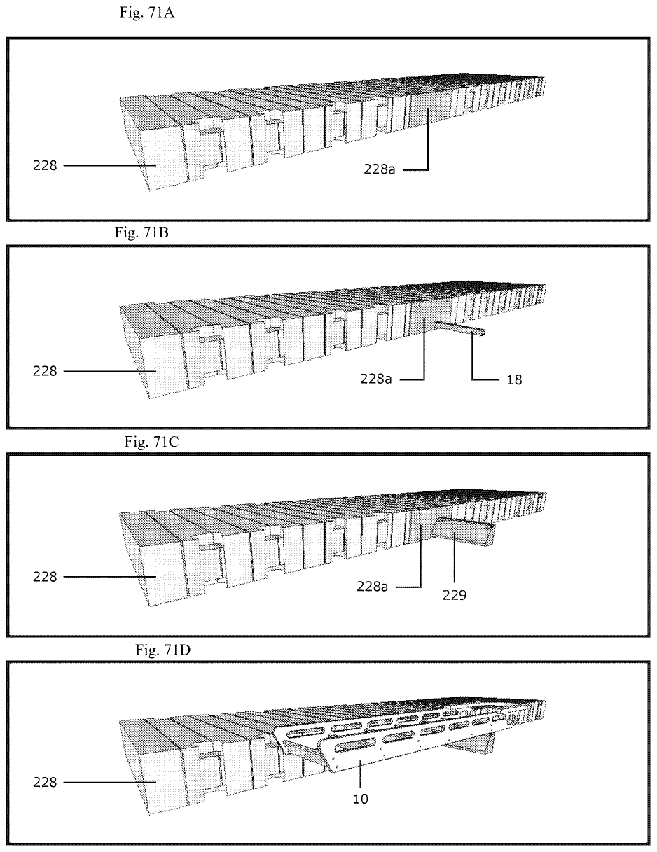

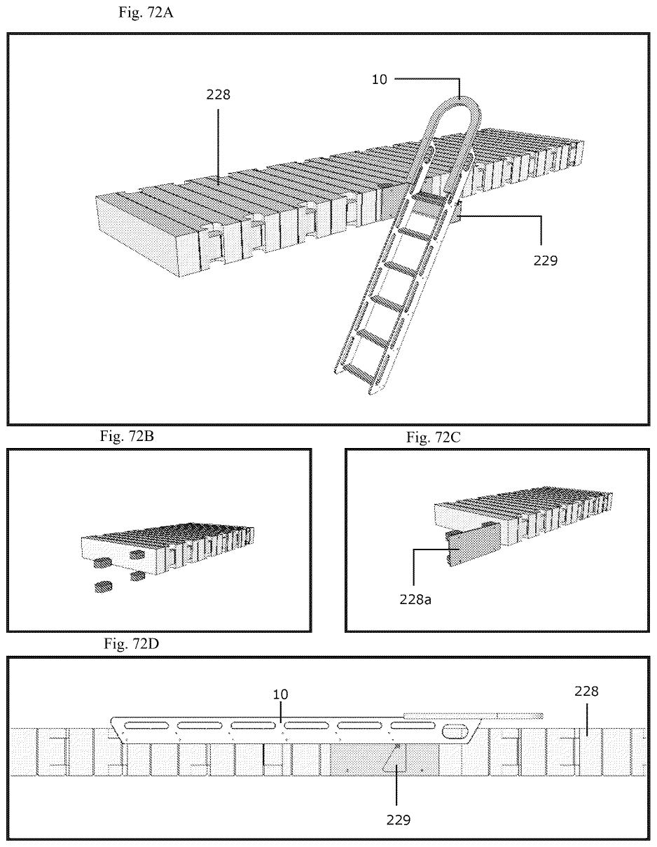

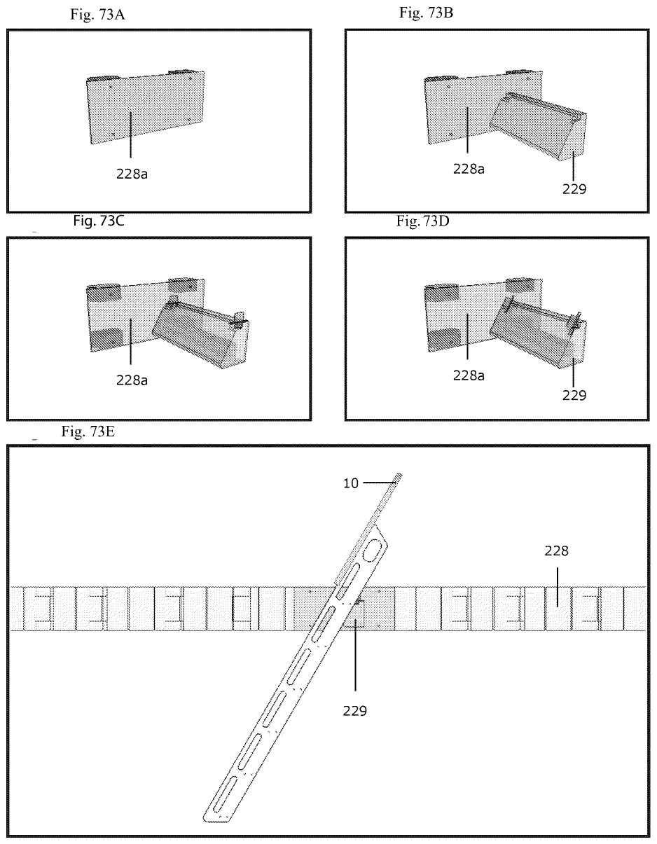

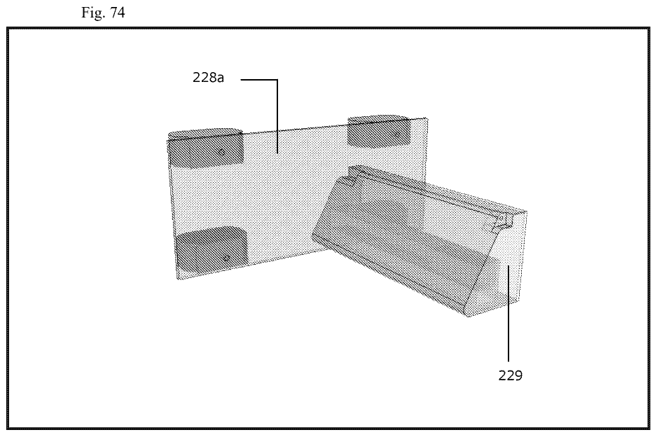

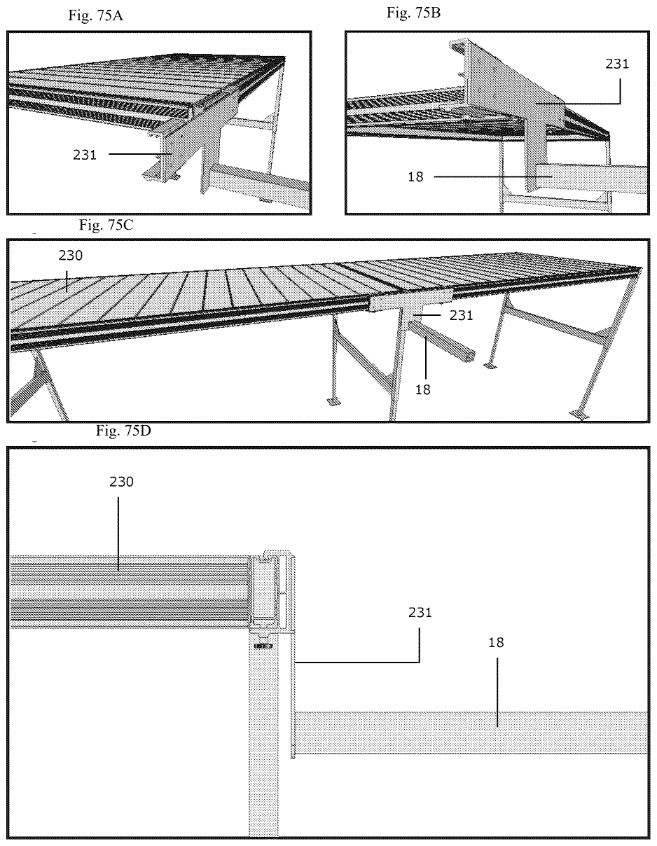

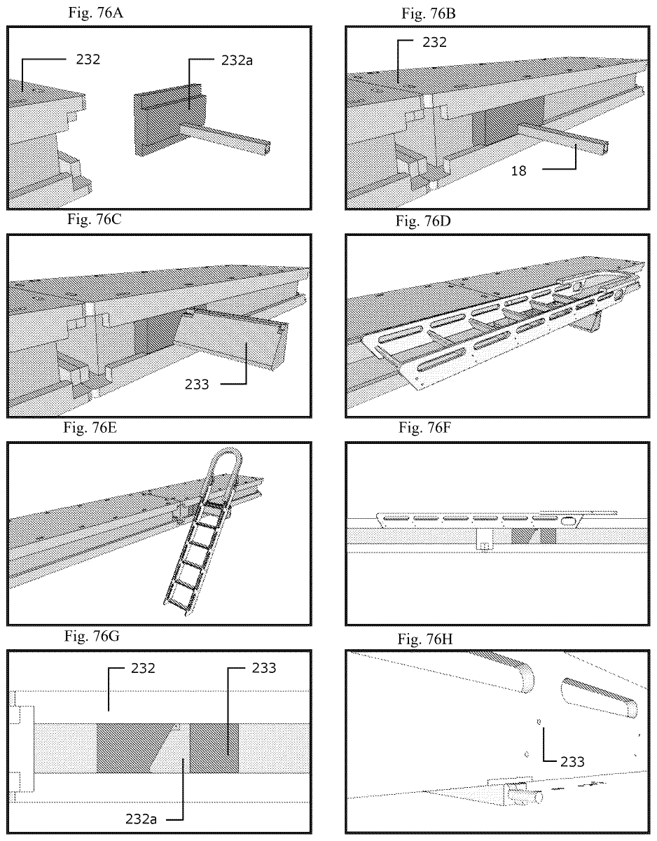

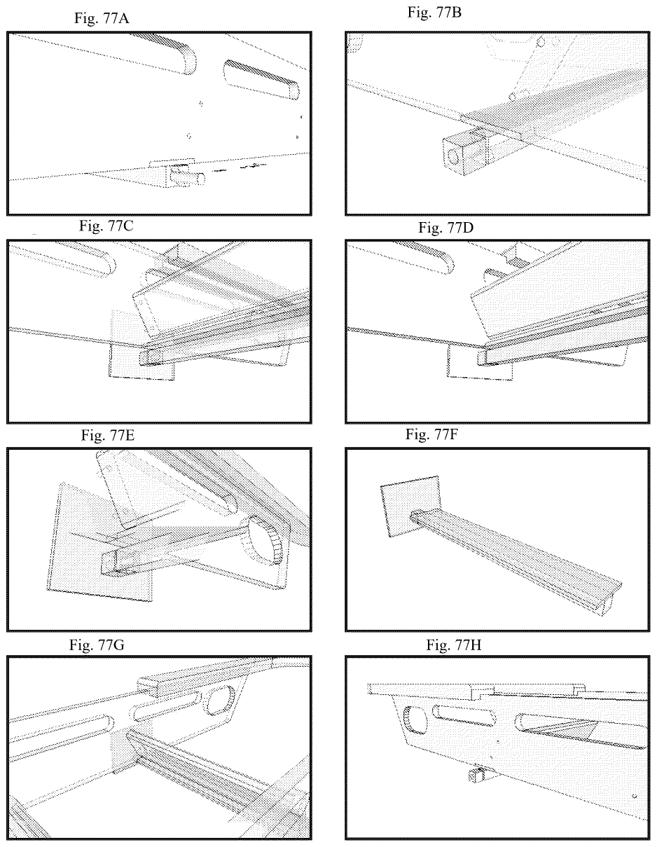

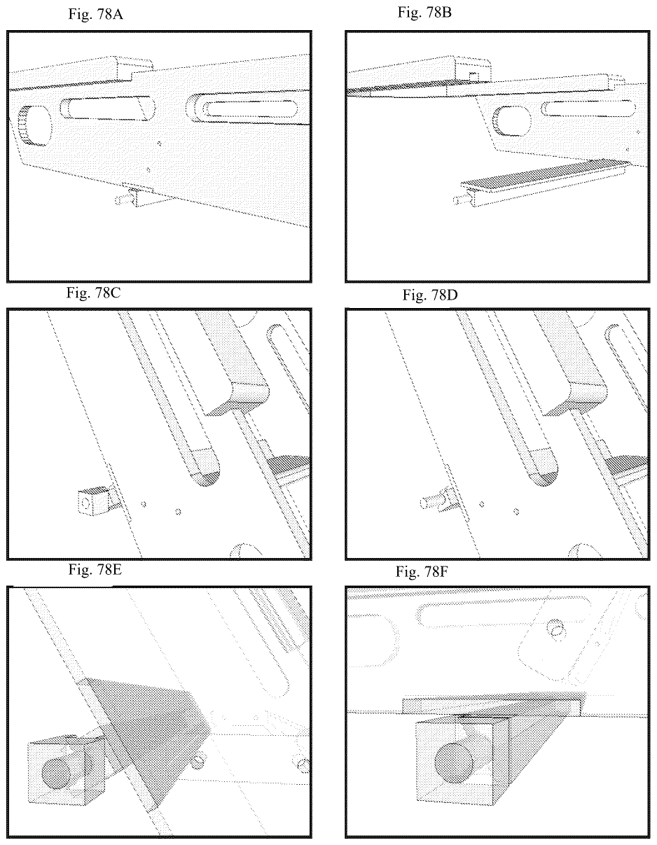

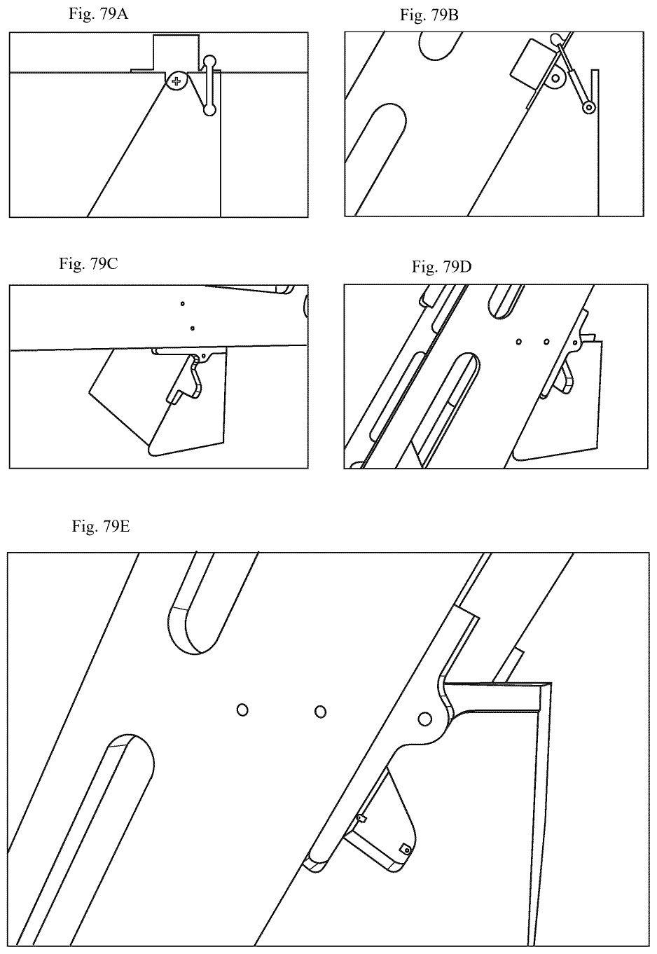

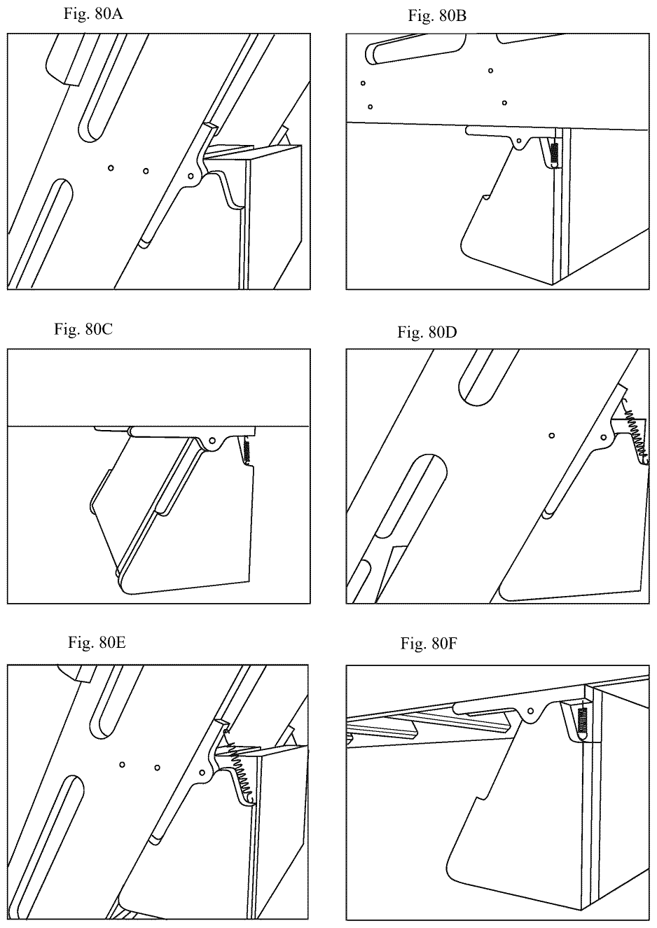

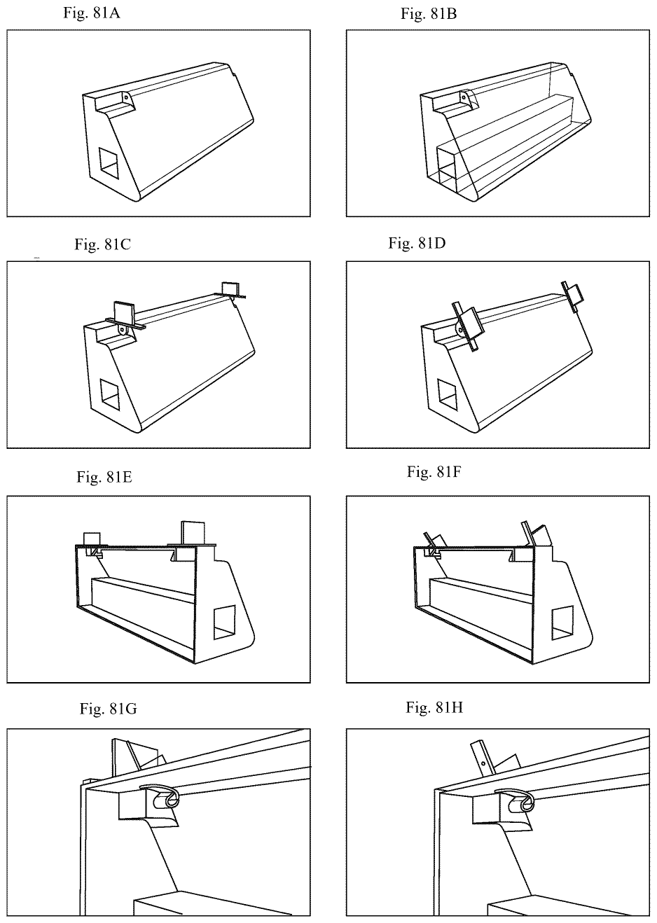

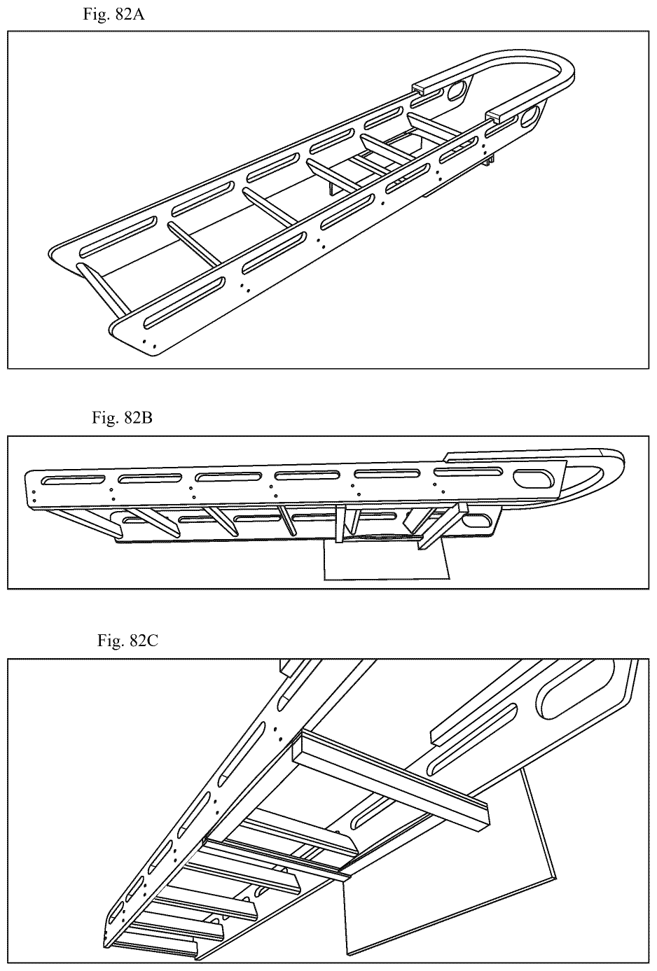

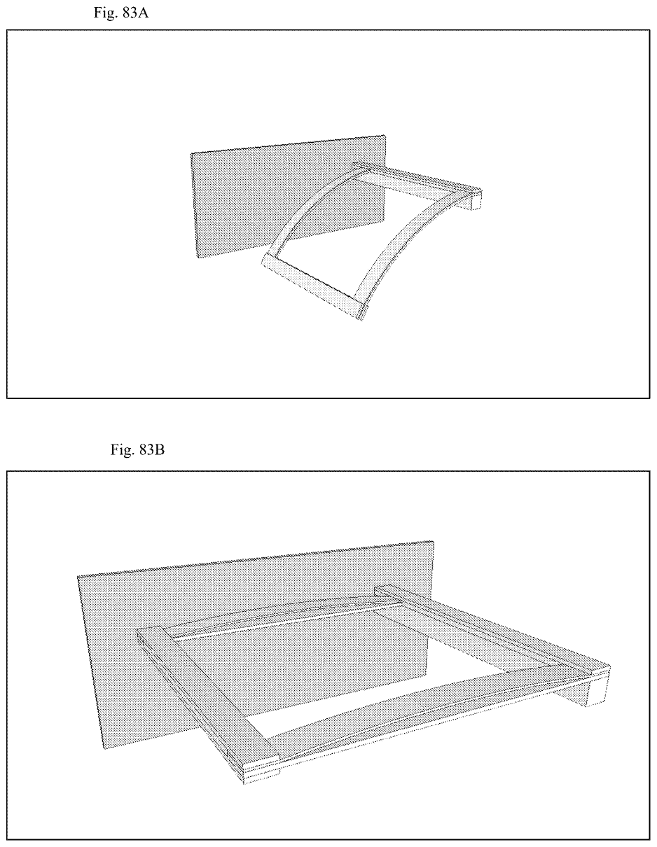

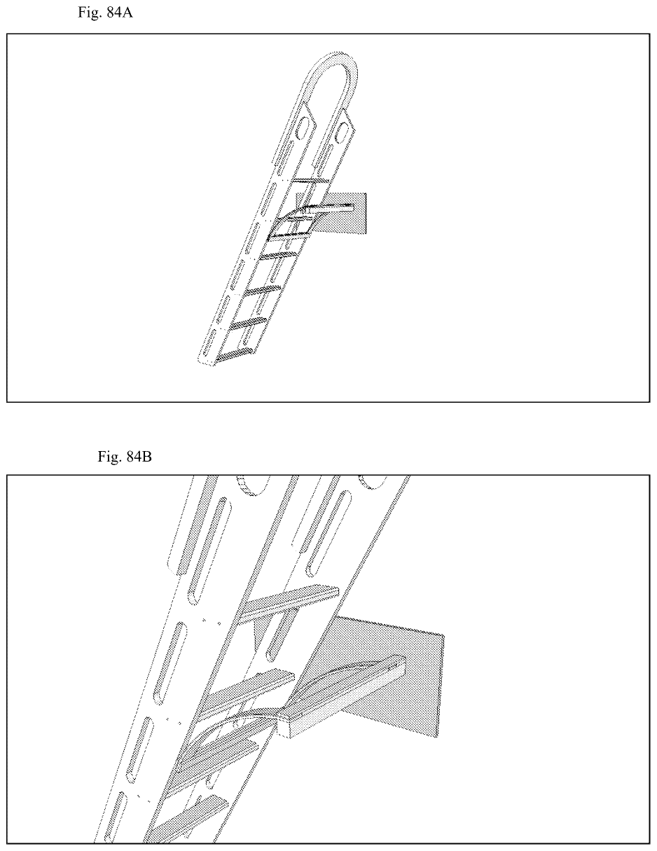

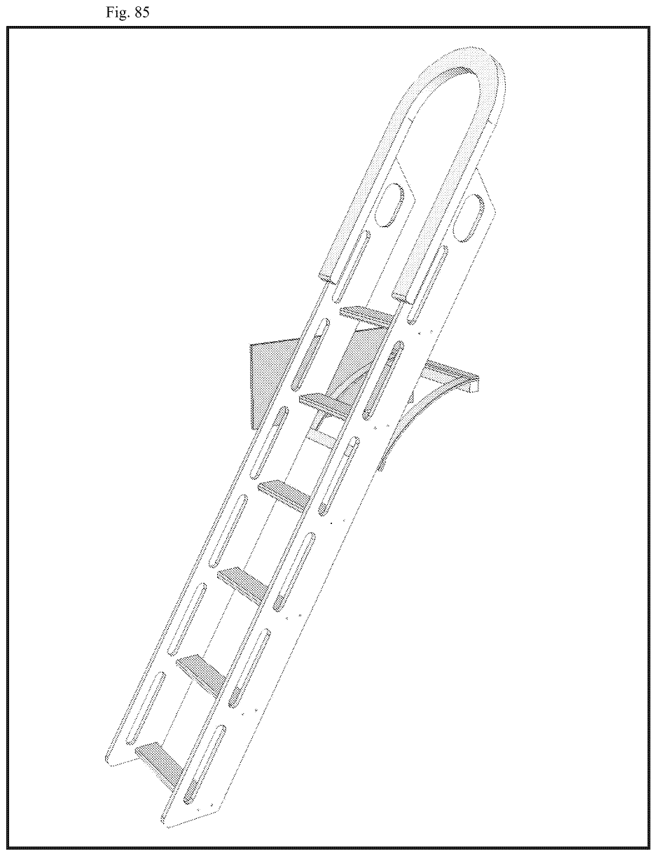

Referring now to FIGS. 51-85, various alternative examples of connections/attachments to the marine ladder of the present invention are shown, as well as alternative examples of the ladder.

Persons of ordinary skill in the art will understand that there are alternative ways to construct the marine ladder of the present invention. For example, instead of a counterweight, the hinged plates could contain and/or provide a spring-loaded or motorized force to cause the ladder to automatically rotate back to a horizontal/resting position, while allowing the ladder to rotate to an in-use position when the user's weight or her/his force is applied to the ladder. If a spring system were used, for example, such a system could consist of a custom-made, constant tension spring, such as a clock spring. The spring would be responsible for retrieving the ladder to its in-use position. The spring could work in tandem with a dampener to control the rate of retrieval. If different lengths of ladder were used (changing the overall ladder length), the spring could either be replaced, or the spring tension could be manually adjusted to accommodate the desired ladder length. As one example, one end of the spring could be fixed to the aluminum hinge body, and the other end of the spring could be attached to the set pin on the ladder.

In another example, elastic bands could be used to drive rotation of the ladder. Other motive means could be hydraulics, pneumatics, compression bushings, torsion rods, etc.

Those of ordinary skill in the art will now appreciate that the marine ladder of the present invention may newly installed onto virtually any apparatus in or near the water, or may be retrofit to an existing apparatus. Non-limiting examples of apparatus the marine ladder of the present invention may be attached to include: standing sectional docks (such as the Great Lakes®, Shore Master®, Twin Bay®, Bulmann®, DH® and E-Docks® brands); standing wheel-in docks (such as the Pier Pleasure® and Ridgeline® brands); floating docks (such as the Wave Armor® and EZ Docks® brands); swim rafts (such as the Otter Island®, Aqua Swim Rafts® and Aqua Cycle® brands); mobile swim loading platforms; breakwalls; bulkheads; boats of any kind that have relatively near access to the water surface surface, including house boats, cabana boats and party boats; above-ground pools, etc.

At a suitable angular inclination when in use, such as at a 60° angle, and preferably utilizing a wide frame, deep treads, side rail handles/railing and a suitable handle such as the U-shaped disclosed here, these features of the marine ladder of the present invention provide users with an ease of transitioning from dock to ladder and vice versa, and it becomes more of a staircase than a ladder. Young, old, weak, disabled, heavy-set and even animals such as dogs and cats can participate in many water activities where a ladder is needed to enter or exit. While a young healthy family may not struggle with traditional 90°, small-rung ladders, they surely have family and loved ones who do.

The universal hinge mechanism that is employed with the marine ladder of the present invention may have a quick-release function, allowing the marine ladder to be transferred, for example, between a boat and a dock, and vice-versa.

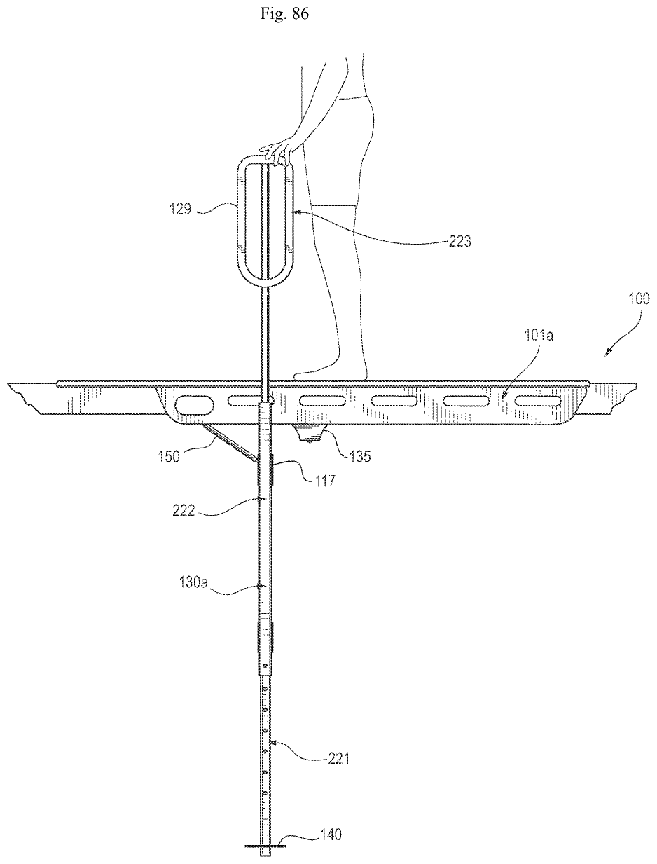

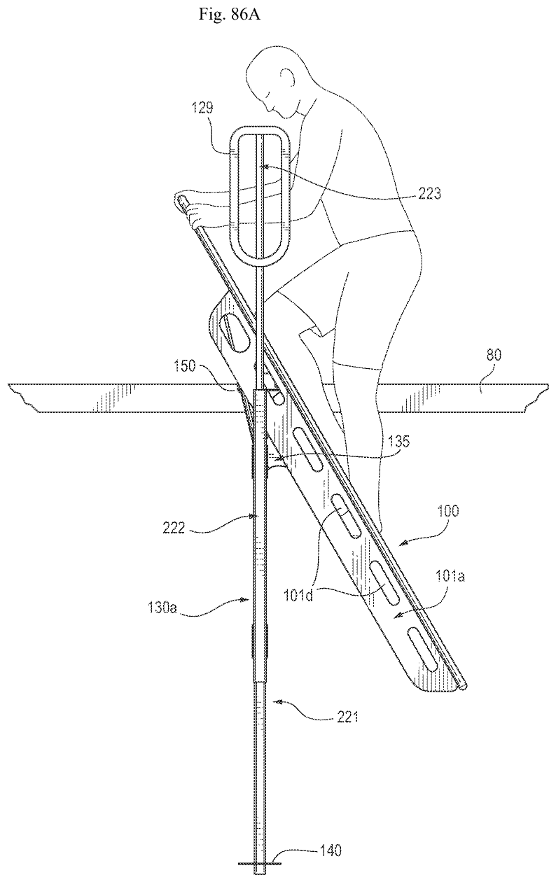

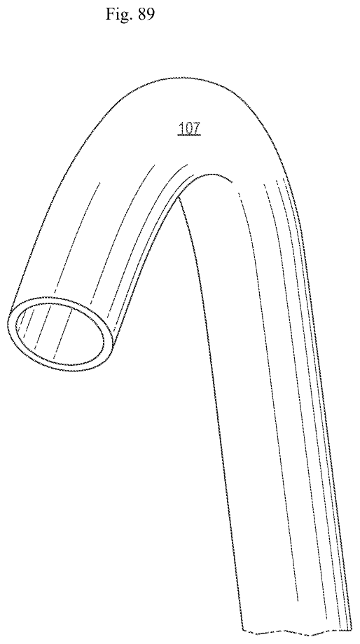

Referring now to FIGS. 86-93, another embodiment of the present invention is disclosed. Referring first to FIGS. 86-88, marine ladder 100 is rotatable relative to, and attached to, dock 80 as described below. Ladder 100 is preferably made of a lightweight metal such as aluminum, except as noted below, and may include the following components: handrail 101 having left and right ladder sidewalls 101a, 101b (which may be made of aluminum), and a handrail endcap 101c; ladder cutouts 101d, both for aesthetics and to minimize material used; a top step 103 and several remaining steps 104, such as the four shown (which may be made of aluminum); left and right sides of the curved handle of the handrail, 106, 107, respectively (see FIG. 89; preferably made of Delrin®, a high-performance engineered thermoplastic acetal resin known for its stiffness, durability and dimensional stability); the base layer 108 of the curved handle of the handrail (may be aluminum); middle layer 109 of the curved handle of the handrail (may be aluminum); handle spacer 110 is a partial curved layer on the curved handle of the handrail (may be aluminum), filling the gap between the middle 109 and base 108 layers, as also shown in FIG. 89. It may be useful to utilize the different layers of the guide rails, as shown, for manufacturing purposes: an outer layer 107 of Duralin® can be machined (or cast) more easily than aluminum, which can be laser cut, for example. Instead of left and right sides 106, 107, the handrail could alternatively be manufactured as a single, unitary structure.

Transfer bar 129 (may be aluminum or ABS, or may be covered with rubber for extra grip support) provides a place for users to hold onto and balance on the ladder during ascending/descending. Transfer bar 129 may be connected to leg 130a using transfer bar handle 223.

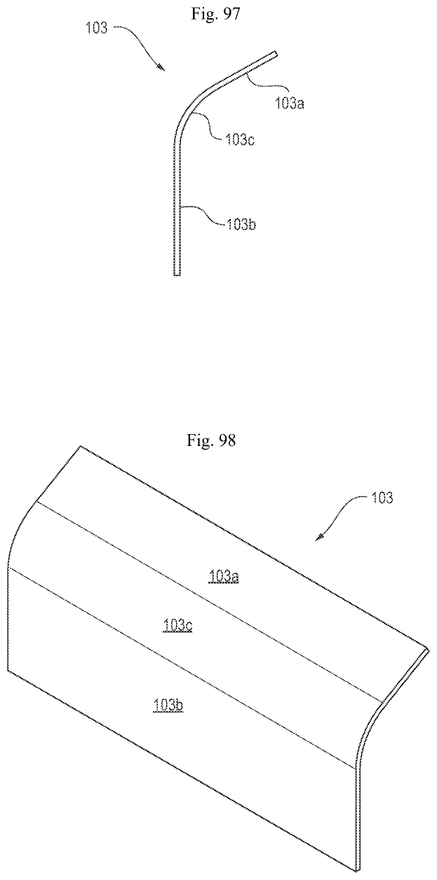

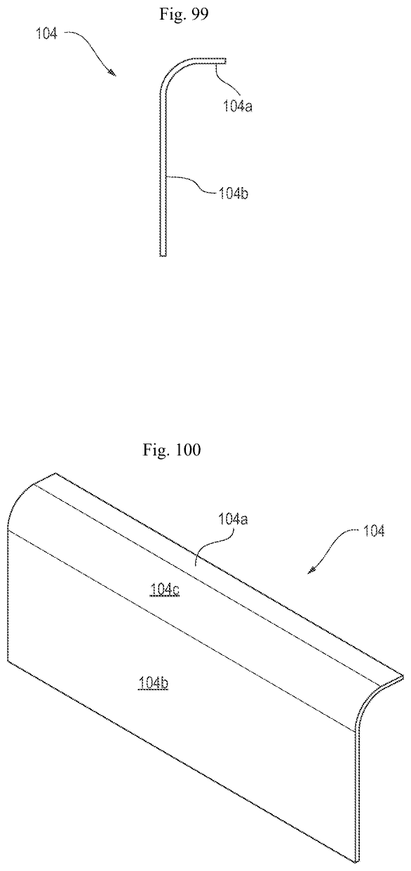

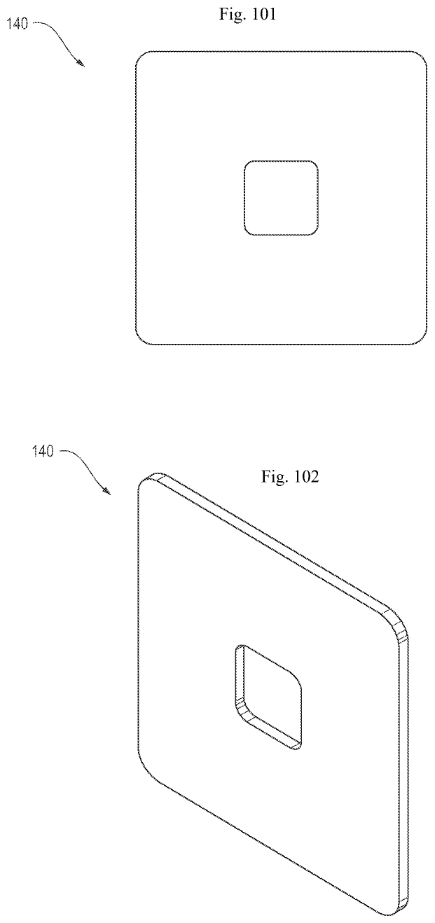

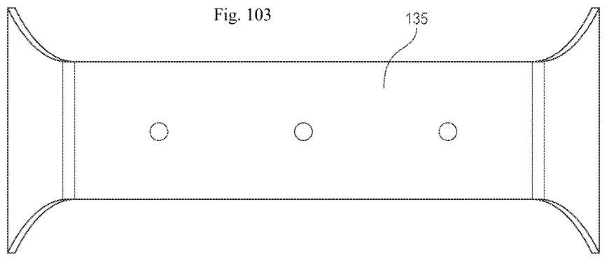

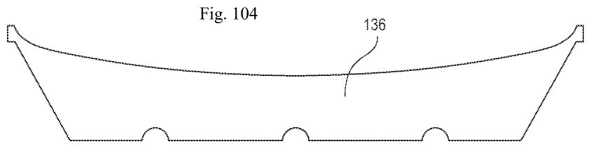

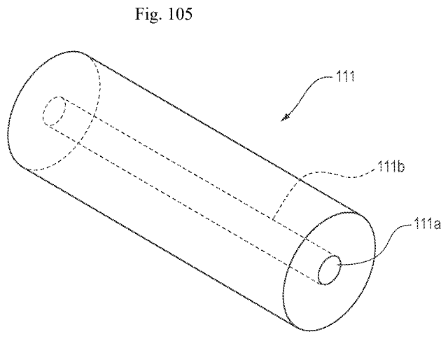

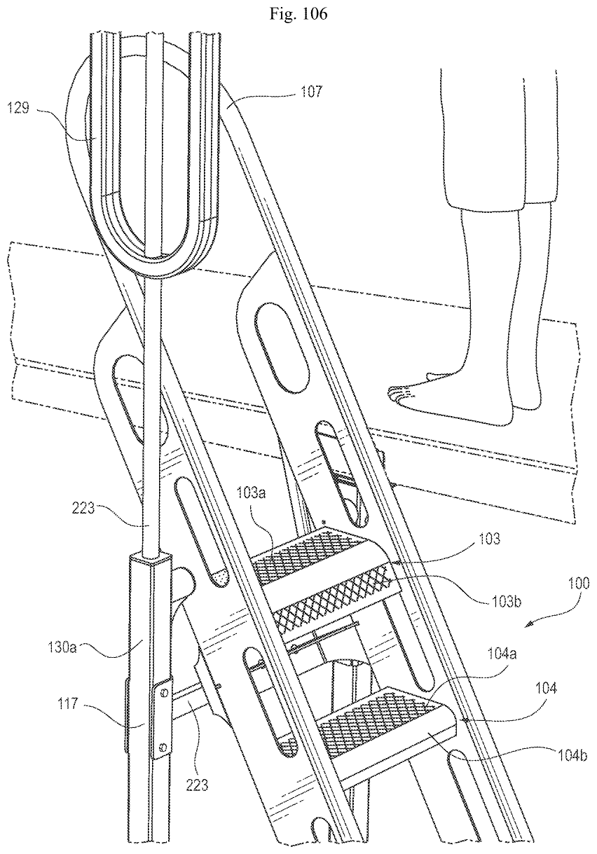

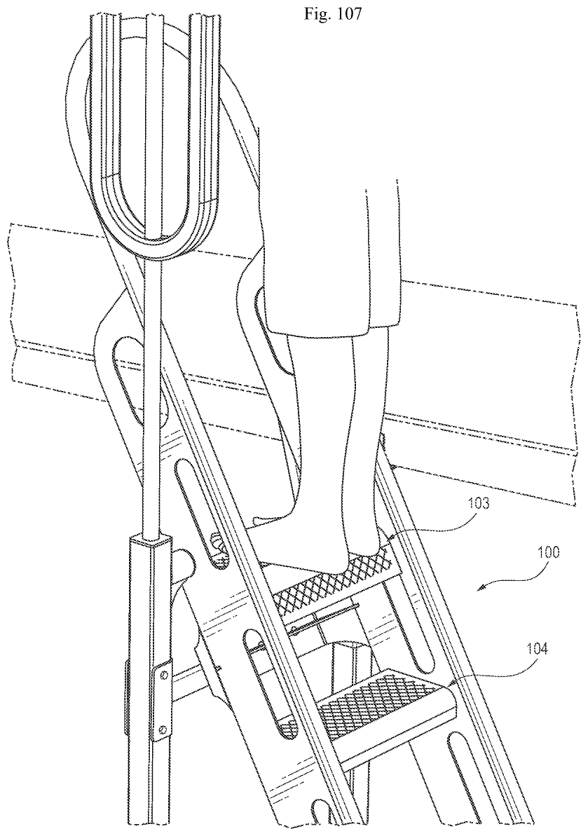

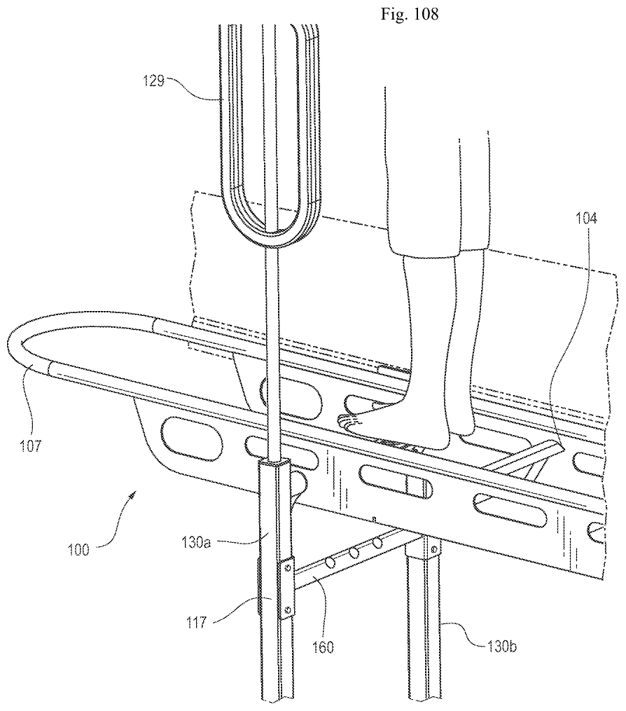

Referring to FIGS. 97-98 and 106-108, top step 103 preferably has a “boomerang” radiused angle shaped to anatomically conform to the human foot (the inside obtuse angle may be, e.g., about 120°). The upper, planar-shaped portion 103a of step 103 may have a length (e.g., about 2 inches) that is about one-half of the lower, planar-shaped portion 103b of the step. Referring to FIGS. 99-100, given the differing body position as a user descends the remaining steps, remaining lower steps 104 may have a smaller inside obtuse angle portion 104c (e.g., about 90°). The upper, planar-shaped portion 104a of step 104 may have a length (e.g., about 1 inch) that is about one-fifth of the lower, planar-shaped portion 104b of the step. Preferably, and as shown, the treads hug the feet contours as the ladder rotates. Thus, a user's feet are comfortably placed on flat portion 103 a of top step 103 when the ladder is in its initial, angled (e.g., 60°) position, as shown in FIG. 107; then, when the ladder moves to its generally horizontal position, a user's feet may still be comfortably placed on flat portion 103b of top step 103, as shown in FIG. 108. Lower steps 104 may have a “bullnose” radiused angle as shown in FIGS. 99-100, allowing a safe, smooth transition into and out of the water.

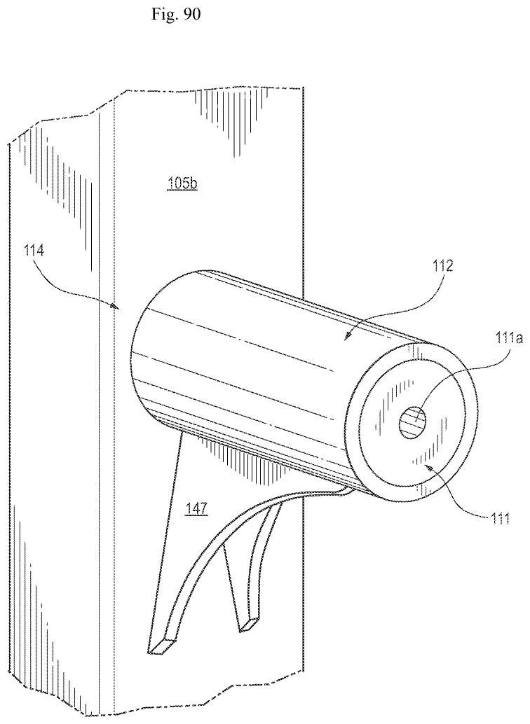

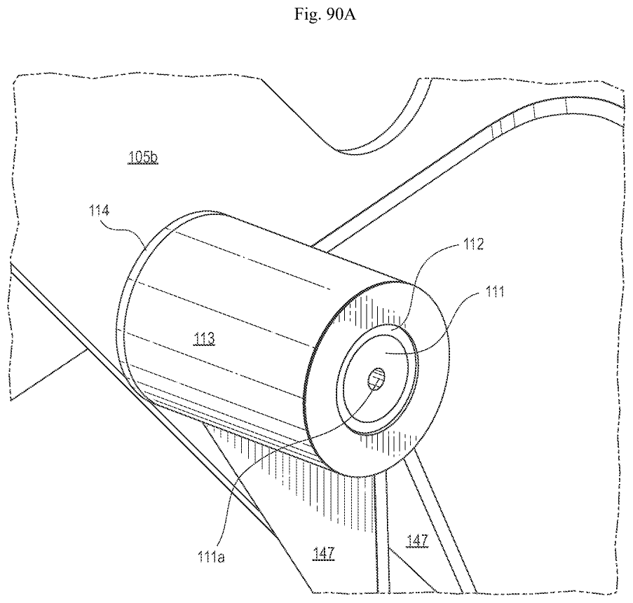

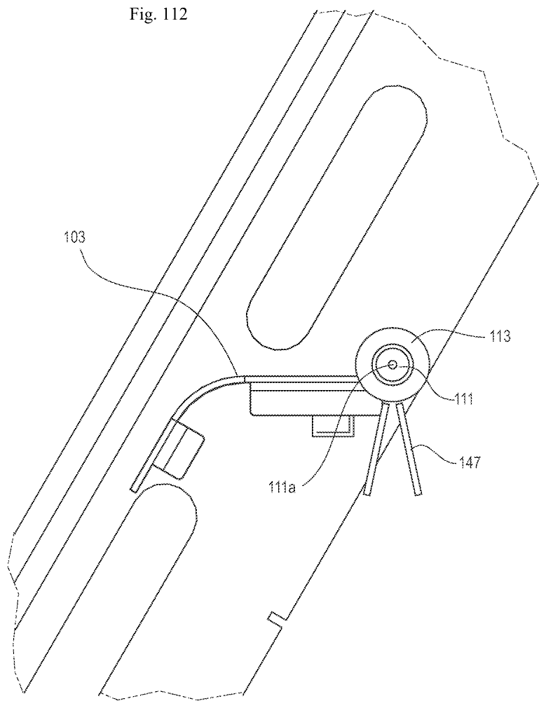

Referring now to FIGS. 90, 90A, 105 and 112, one preferred embodiment of a “support element” (as recited in the claims) will now be described, which enables the ladder to pivot relative to the fixed frame legs. Middle pivot cylinder 111 (may be aluminum) is a metal cylinder which may be welded or bolted to the side of the ladder, and provides support for the rotary point of the ladder. Pivot inside ring 112 (may be Delrin®) is a cylindrical spacer which slides over pivot cylinder 111 and creates a low-friction fitting to allow the ladder to more easily rotate about pivot cylinder 111. Pivot outside ring 113 (may be aluminum) is a metal cylinder whose opposing ends may be welded directly to the two legs of the frame, and which holds the pivot point together and protects the pivot point from impact. Pivot gasket 114 (may be Delrin®) slides over pivot cylinder 111 (abutting the end of pivot outside ring 113) and creates a low-friction barrier between the pivot point and the ladder frame. Pivot cylinder 111 and pivot outside ring 113 rotate around each other with the help of pivot inside ring 112 acting as a low-friction spacer. Pivot gasket 114 facilitates this rotation against the main ladder by reducing friction there. Aperture 111a and passage 111b within middle pivot cylinder 111 allow placement of a bolt (not shown) for attachment to the ladder legs. Removal of this bolt allows pivot cylinder 111 to be quickly decoupled from the fixed frame legs, allowing quick decoupling of the ladder from the frame 130. As shown in FIGS. 90, 90A and 112, gussets 147 may be used to support cylinder 112 and prevent its binding during use.

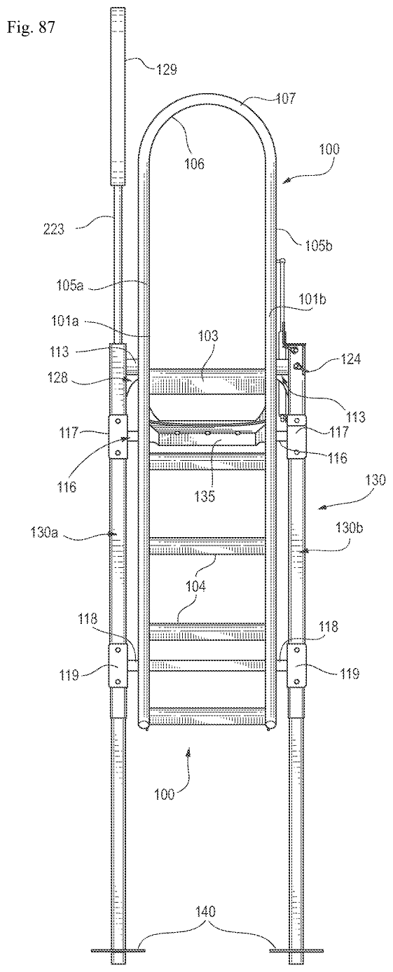

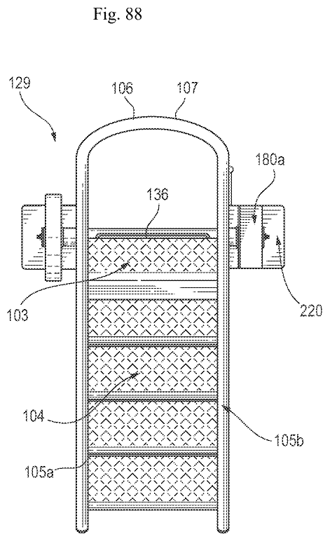

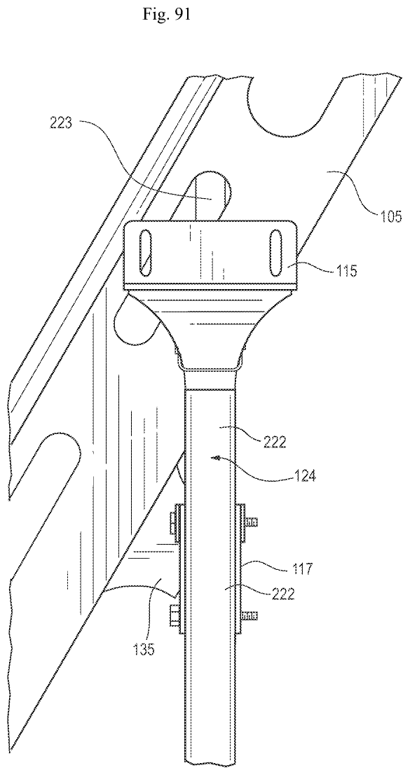

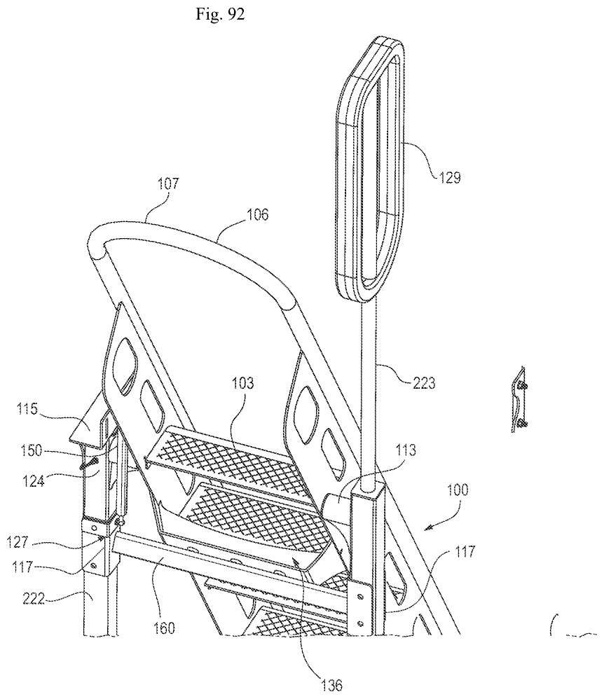

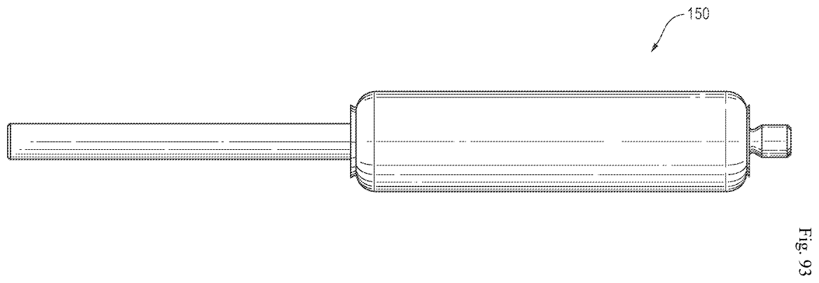

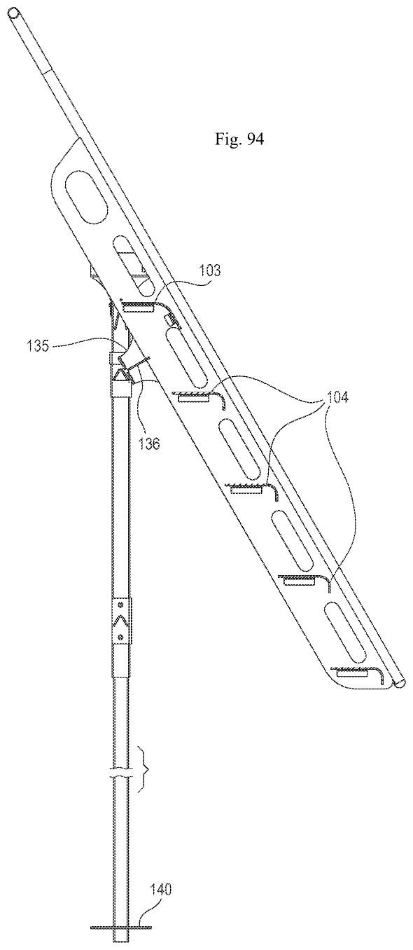

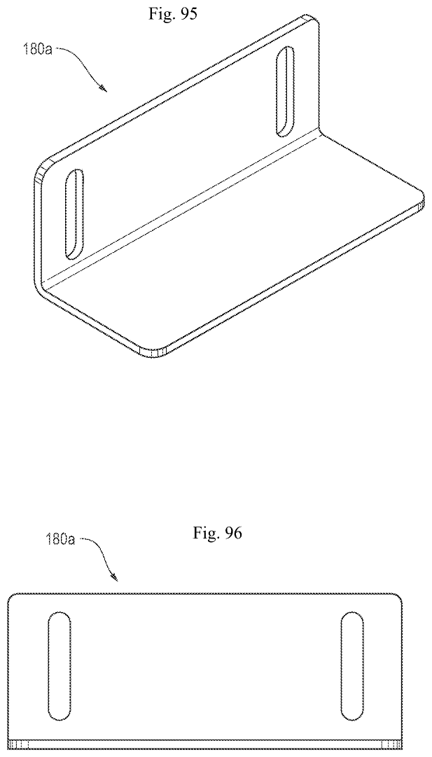

Referring to FIG. 88, top dock bracket 180a (may be aluminum) is the attachment point where the ladder bolts or otherwise attaches to the dock. Removable top dock bracket 180a allows easy removal of the ladder from the dock in one piece. Referring to FIGS. 87, 91 and 92, strut mount plate height bracket top 116 (may be aluminum) provides support against torsional forces at the water surface, and is attached to strut mount plate 117. Strut mount plate 117 (may be aluminum) mounts height bracket top 116 to either leg of the ladder. Strut mount plate 117 may have multiple apertures 117a (as best shown in FIG. 91), which allows for its adjustable connection to one end of cylinder 150 (as best shown in FIG. 92), to provide the user with the ability to best position the cylinder given the ladder environment. Strut mount plate 117 can also be reversed and positioned on the ladder's left or right sides (to account for left-side or right-side dominant users). Height bracket bottom 118 (may be aluminum) provides support against torsional forces from current underwater. Height bracket bottom mount 119 (may be aluminum) mounts height bracket bottom 118 to either leg of the ladder.

Referring to FIGS. 86-87 and 91-92, ladder frame 130 includes legs 130a, 130b attached to ladder 100 using pivot outside ring 113 (FIG. 87) and its adjacent structure (as described above). Legs 130a, 130b may be attached to bottom legs 130c, 130d using brackets 119, and the bottom legs may have a bottom portion attached to an underwater base 140 (may be aluminum) that may be buried below the surface of the lake floor to provide additional support for the ladder. Alternatively, each pair of legs 130a and 130c, and legs 130b and 130d, may form a unitary structure.

Referring to FIG. 87, one of the legs (leg 130b), located on the inner (dock) side of the ladder, may include a leg top 124 (may be aluminum) on the top part of support leg 130b, which supports top dock bracket 180a (described above).

Referring to FIGS. 87 and 92, a rotation bumper 135 (may be aluminum) may be used as a brace located on the underside of the ladder to prevent the ladder from rotating too far and to stop the ladder at a suitable correct angle for ascending/descending (e.g., 60°). This design also has the advantage of minimizing appendage pinch points in the ladder underside area adjacent bumper 135. Rotation bumper gusset 136 (FIG. 92, may be aluminum) can be used to create additional support and structure for rotation bumper 135. Strut mount plate 117 may be used to mount gusset 136 to bumper 135.

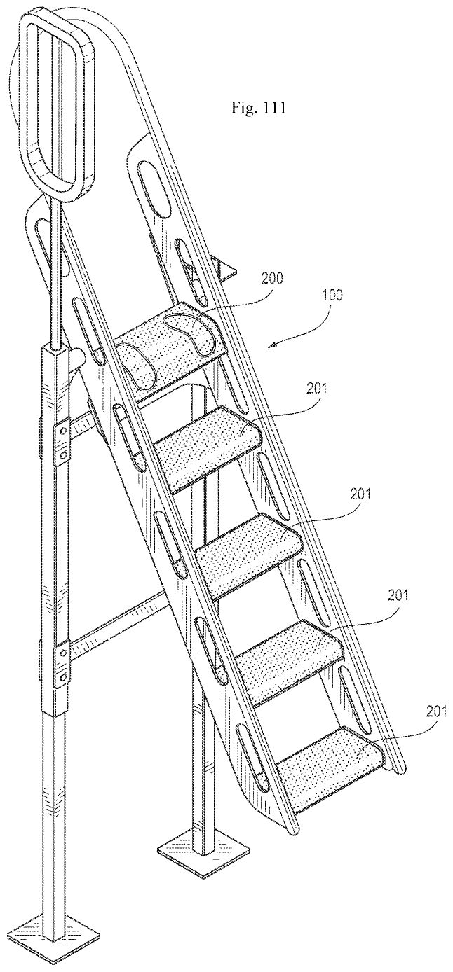

Referring now to FIG. 111, the preferred embodiment of the automatically retractable ladder 100 is shown with foam-covered steps. Top step may be covered with a foam mat with a pattern of human feet, directing the user's placement of foot for best ladder movement and performance.

Referring now to FIGS. 87 and 92, opposing strut mount plates 127 (may be aluminum) may be carried by crossbrace 160 attached between frame legs 130a, 130b. Strut mount plates 127 may also be used to mount pneumatic cylinder 150 so that the pneumatic cylinder is in a position to exert a rotating force on the ladder, as shown. Left-side and right=side frame gussets 128 (FIG. 87, may be aluminum) may be used to provide additional vertical support for the ladder from weight and gravity.

It will be appreciated that fenders or buoys may be located on the outside of the ladder, between the frame leg and the fixed element (e.g. fixed dock), to prevent damage to the frame leg.

The ladder may be anodized to prevent or minimize rust or corrosion, and for a higher-quality surface finish.

Handle 129 can be designed to be readily detachable from leg 130a. Handle 129 can function as an emergency flotation device. It can also be brightly colored, or designed to glow or light in the dark, so that swimmers or boaters can readily locate it if they need to get out of the water quickly, or in emergency situations.

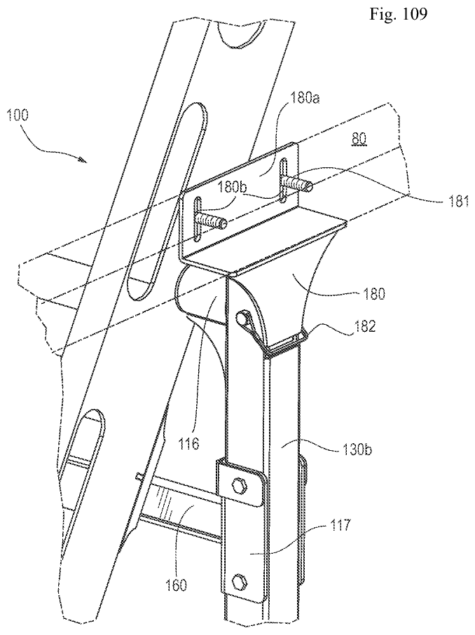

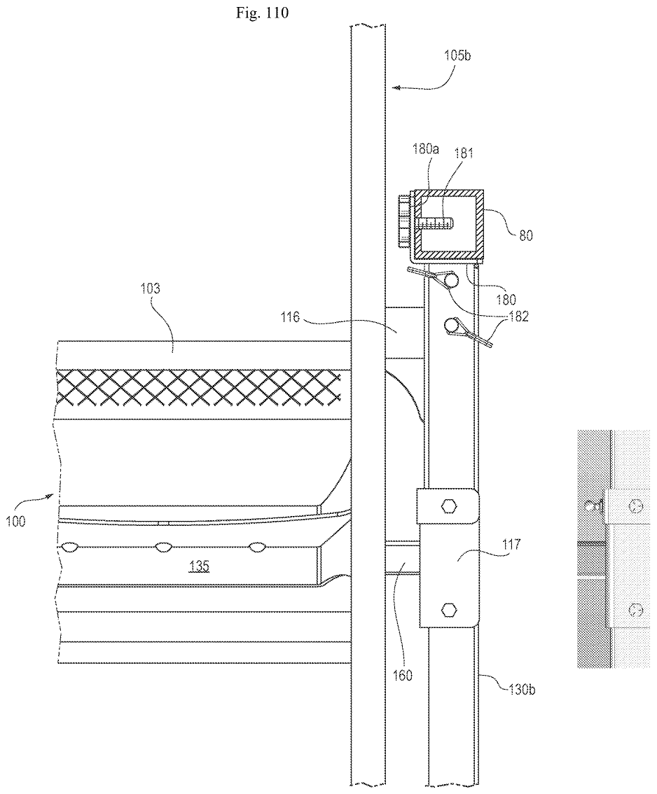

Referring now to FIGS. 109-110, the ladder can be easily removed from a dock or other fixed or floating element (dock, boat, etc.). One preferred embodiment to accomplish this is shown. On one of the support legs 130, bracket mount 180 may include oval or C-channel tracks 180b on vertical portion 180a to accommodate fasteners 181 for removeable attachment to deck 80. This design avoids the “blind” attachment which might otherwise be required. C-channel tracks are useful so that carriage bolts or other fasteners can be located and tightened anywhere within the track, easily allowing for different ladder heights. Removable pintle hook 182 can be used to adjust the height of bracket mount 180 relative to support leg 130a.

Referring now to FIGS. 109 and 110, a top portion of ladder leg 130b may include a dock connection bracket 180. Dock connection bracket 180 may include vertical channels 180b to accommodate fasteners connecting the bracket to dock 80, as shown. Pintle hooks 182 may be used, as shown, to removably secure leg 130a to the dock. This arrangement allows the ladder to be easily removed from the dock for maintenance, even though it is a “blind” removal.

A locking mechanism, stop or détente (not shown) may be used to allow the ladder to be locked in an angular or horizontal position by the user. This may be advantageous if, for example, the user desires to pull a kayak or other equipment onto a dock or boat using the ladder, or for ladder-related maintenance (e.g., replacement of cylinder/linear actuator 150).

The rotational rate of speed of the ladder is relatively important from a safety and efficiency standpoint. If the ladder moves too fast, it can surprise or dislodge users, while if it moves too slow, it can frustrate the efficiency of the ladder operation. After a great deal of field operation, it was decided that a useful rotational rate for the ladder is about 10-50°/second, and most preferably about 10-25°/second. Because the ladder will normally move through the air faster than it moves through the water (the treads act as a sail, so that as the ladder hits the water, it normally slows substantially), it may be useful to slow the ladder as it approaches the water, to avoid a “slap” on the water and to avoid putting undue strain on the ladder or its components, including the cylinder. For this purpose, it was found useful to provide cylinder 111 with a dampening effect on the last about one-third of its downstroke. In one preferred embodiment, and referring now to FIGS. 92 and 93, one example of a preferred air cylinder 150 is a reverse traction gas strut, such as a Bansbach easylift air cylinder, traction gas spring with damping (Model Number A3A3Z93-200-532-002/775N) with a 200 mm stroke length, a 175 pound (775 Newton) force rating, AISI 303 stainless steel elbow joint end fittings. piston rod, a compressed length of 472 mm, and providing a compression force of 200-1200 Newtons. This cylinder is completely sealed with a pressureless chamber. In a preferred embodiment, the ladder length is about 102 inches, and the distance from the pivot to the top of the ladder is about 40 inches, while the distance from the pivot to the bottom of the ladder is about 62 inches.

The ladder can be powered, by a battery or solar or wind power. The ladder can be a “smart” design, which can alert owners to when the ladder is in use, or which can monitor real-time conditions, such as tide, waves, wind, or other lake conditions such as the presence of algae blooms, or other geodata which can be collected.

Persons of ordinary skill in the art will also appreciate that the principles of the present invention may be employed in settings outside the marine environment, including retractable ladders used in pools, factories, libraries, shop floors, mezzanines, equine applications (e.g., to help mount and dismount from horses), etc.

The above description is not intended to limit the meaning of the words used in the following claims that define the invention. Persons of ordinary skill in the art will understand that a variety of other designs still falling within the scope of the following claims may be envisioned and used. It is contemplated that these additional examples, as well as future modifications in structure, function, or result to that disclosed here, will exist that are not substantial changes to what is claimed here, and that all such insubstantial changes in what is claimed are intended to be covered by the claims.

I claim:

1. An automatically retractable marine ladder positioned adjacent a fixed element located in or adjacent to a body of water, comprising:
a ladder having opposing upper and lower ends ends, a pair of opposing siderails, and a plurality of treads attached to the opposing siderails;
a frame with opposing legs supporting the ladder, wherein the frame is rigidly attached to the fixed element;
a support tube with a force generating element, the support tube pivotably attached to at least one of the ladder siderails and rigidly attached to at least one of the opposing legs of the frame, wherein the support element drives rotation of the ladder relative to the frame and to the fixed element;
wherein the force generating element causes the ladder to be generally horizontally positioned when the ladder is not in use, and wherein the force generating element enables rotation of the ladder to a predetermined angular position when force or body weight is exerted on one or more of the siderails or on one or more of the treads of the ladder, thereby enabling ladder users to step onto the ladder, descend the ladder, and then exit the ladder to water, or to leave the water, pull down on the ladder to move the ladder from the generally horizontal position to the predetermined angular position, ascend the ladder, and then exit the ladder onto the fixed element; and
wherein following the exit of the user from the ladder, the force generating element causes or allows the ladder to automatically rotate from the predetermined angular position to the generally horizontal position.

2. The automatically retractable marine ladder of claim 1, wherein the force generating element comprises one or more of the following: a pneumatic cylinder; a hydraulic cylinder; a cantilever weight; a spring; a motor.

3. The automatically retractable marine ladder of claim 1, wherein the support tube may be quickly coupled and decoupled from the fixed element, thereby freeing the marine ladder from the fixed element for maintenance or repair, or for attachment of the marine ladder to a different fixed element.

4. The automatically retractable marine ladder of claim 1, wherein the fixed element comprises one or more of the following: a standing sectional dock; a standing wheel-in dock; a floating dock; a swim raft; a mobile swim loading platform; a breakwall; a bulkhead; a boat; a bridge; an above-ground pool, including a hot tub; or an in-ground pool, including a hot tub.

5. The automatically retractable marine ladder of claim 1, further comprising a transfer bar acting as a handrail and located near an upper end of the ladder.

6. The automatically retractable marine ladder of claim 1, wherein the transfer bar is curved, easily graspable by a user, and rigidly attached to a frame leg.

7. The automatically retractable marine ladder of claim 1, wherein the predetermined angular position is about 60° relative to ground.

8. The automatically retractable marine ladder of claim 1, wherein the rate of rotational movement when the ladder is returning to its resting position is about one foot/second.

9. The automatically retractable marine ladder of claim 1, further comprising a dampener associated with the support element and the ladder that fixes and cushions rotational ladder movement as the ladder comes to a rest at the predetermined angular position.

10. The automatically retractable marine ladder of claim 1, wherein the support element comprises first and second concentric, rotating cylindrical rings, and a rotatable cylindrical spacer interdisposed between the two rings, and wherein the first ring is attached to the frame and the second ring is attached to the ladder.

11. The automatically retractable marine ladder of claim 1, wherein the treads are curved, and shaped to hug the contours of a human foot as the ladder rotates.

12. The automatically retractable marine ladder of claim 1, wherein at least the top tread has first and second substantially planar sections separate by a curved section, and wherein the first substantially planar section presents a substantially flat contact surface to a user foot when the ladder is in the generally horizontal position, and then as the ladder rotates to the predetermined angular position, the second substantially planar section presents a substantially flat contact surface to a user foot when the ladder is in the predetermined angular position.

13. The automatically retractable marine ladder of claim 12, wherein the two substantially planar sections, if connected by straight lines, would form an obtuse angle.

14. A method for using an automatically retractable marine ladder having upper and lower ends, a pair of opposing side rails, a plurality of treads, a support element pivotably attached to at least one of the ladder side rails and also to a fixed frame, wherein the fixed frame is rigidly attached to a fixed element located in or adjacent to water, wherein the support element enables the ladder to rotate relative to the fixed frame, and a force generating element attached to the fixed frame and adapted to exert a rotational force on the ladder, while causing the ladder to be located in a generally horizontal position when not in use, comprising the steps of:
a user mounting the ladder from the fixed element begins to descend the ladder, thereby exert force or body weight on one or more of the ladder siderails or one or more of the ladder treads, causing the ladder to rotate from the generally horizontal position to a predetermined angular position, and allowing the user to exit the ladder into the water;
once the user has exited the ladder and is in the water, the ladder will automatically rotate back to the generally horizontal position, due to rotational force exerted on the ladder by the force generating element;
when the user wishes to exit the body of water and re-mount the ladder, the user while in the water pulls down on one or more of the ladder siderails or on one or more of the ladder treads, thereby causing the ladder to move to the predetermined angular position, and enabling the user to ascend the ladder and then exit the ladder to the fixed element; and
following the exit of the user from the ladder, the ladder is once again caused or allowed by the force generating element to automatically rotate back to the generally horizontal position.

15. The method of claim 14, wherein the force generating element comprises one or more of the following: a pneumatic cylinder; a hydraulic cylinder; a cantilever weight; a spring; a motor.

16. The method of claim 14, further comprising the step of the support element being quickly decoupled from the fixed element, thereby freeing the marine ladder from the fixed element for maintenance or repair.

17. A ladder capable of rotating between a generally horizontal position, and a fully rotated position which is substantially rotated away from the generally horizontal position, wherein the ladder has a plurality of steps, including a top step, and wherein the top stop has a top planar portion and a bottom planar portion, and a curvature exists between the top and bottom planar portions, whereby when the ladder is in the fully rotated position, a user foot is capable of being supported by the top planar portion, and when the ladder is in the generally horizontal position, the user foot is capable of being supported by the bottom planar portion.

18. The ladder of claim 17, wherein in the fully rotated position, the ladder is rotated to form an acute angle of about 60° from ground.
